(19) United States
(12) Patent Application Publication
(10) Pub. No.: US 2018/0283608 A1
(43) Pub. Date: Oct. 4, 2018

(54) PRESSURIZED GAS CONTAINER

(71) Applicant: STRAUSS WATER LTD., Petach Tikva (IL)

(72) Inventors: Haim WILDER, Ra'anana (IL); Eyal KRYSTAL, Kfar Saba (IL); Rami RONEN, Ramat Hasharon (IL)

(21) Appl. No.: 16/002,787

(22) Filed: Jun. 7, 2018

Related U.S. Application Data
(63) Continuation of application No. 14/811,055, filed on Jul. 28, 2015.
Application No. 14/811,055 is a continuation-in-part of application No. PCT/IL2015/050109, filed on Feb. 1, 2015.
(60) Provisional application No. 61/935,357, filed on Feb. 4, 2014.
(60) Provisional application No. 61/985,540, filed on Apr. 29, 2014.
(60) Provisional application No. 62/044,344, filed on Sep. 1, 2014.
(60) Provisional application No. 62/067,538, filed on Oct. 23, 2014.
(60) Provisional application No. 62/120,443, filed on Feb. 25, 2015.

(51) Int. Cl. F17C 1/00; B67D 1/00; B67D 1/04

(52) U.S. Cl. CPC F17C 1/00; F17C 2223/0123; F17C 2221/013; F17C 2209/234; F17C 2205/032; F17C 2205/0314; F17C 2205/0165; F17C 2205/013; F17C 2205/0111; F17C 2203/0617; F17C 2201/058; F17C 2201/0119; F17C 2201/0109; B67D 2001/0092; B67D 1/0418; F17C 2223/036; B67D 1/0071

(57) ABSTRACT

A pressurized gas container associates with and supplies gas to a pressurized gas port of an appliance, such as for supplying carbon dioxide for the preparation of a carbonated drink. The container has a plug at its opening that has a barrier element that seals the container and is configured to be non-reversibly ruptured by a shaft of a gas-channeling member. The plug also has one or more sealing elements that are distinct from the barrier element and are configured for forming a gas-tight association with the shaft of the gas-channeling member. A plurality of such pressurized containers may be carried by a holder rack in a multipack. An appliance adapted for preparing or dispensing carbonated drink includes an adapter for associating with such a pressurized carbon dioxide-containing canister and for receiving the pressurized carbon dioxide therefrom.

### TECHNOLOGICAL FIELD

The present disclosure concerns a pressurized gas container, for example one containing carbon dioxide for use in a device or system for the preparation of a carbonated drink. The present disclosure also provides a plug that may be functionally integrated into the container and further provides a packaging with a plurality of such containers.

### BACKGROUND ART

References considered to be relevant as background to the presently disclosed subject matter are listed below:
GB 2,176,586
U.S. Pat. No. 3,587,926
U.S. Pat. No. 3,684,132
TW M370038

Acknowledgement of the above references herein is not to be inferred as meaning that these are in any way relevant to the patentability of the presently disclosed subject matter.

### BACKGROUND

Pressurized gas containers are typically used in systems or appliances that require in-feed of pressurized gas. An appliance for the preparation of a carbonated beverage is one such example. Most pressurized gas containers are designed for multiple use, i.e. the container's volume and/or gas pressure are sufficient for several gas-feed doses. This typically requires the container to be associated with a mechanism allowing connecting and disconnecting gas flow between the container and the appliance or system. Often, the container itself is equipped with a gas-flow control mechanism, such as a valve or a re-sealable membrane, to permit a user to disconnect the container from the appliance or the system while preventing gas leakage from the container.

In addition, the containers are often designed for multiple use cycles, i.e., once the container is emptied, it is often shipped back to the provider for cleaning and re-filling. Such a container is typically designed to meet strict safety requirements, such as relatively thick wall thickness and robust re-sealable opening in order to minimize accidental rupturing of either the seal or the container. This, however, results in high production costs and complex logistics. Moreover, many such containers are not returned after utilization to the supplier for re-filling, resulting in relatively high sunk-costs.

There is therefore a need for disposable pressurized gas containers which are intended for a single use in an appliance or a system, such as an appliance for the preparation of a carbonated drink.

### GENERAL DESCRIPTION

Provided by an aspect of this disclosure is a new pressurized gas container, in particular but not limited to a pressurized carbon dioxide canister for use in appliances or systems for the preparation of carbonated drinks. The new container is intended for single use, meaning that it may be used until its content of pressurized gas is exhausted and then discarded, e.g. disposable after use. For example, a carbon dioxide canister of this disclosure is coupled to a system or appliance and may be used for preparing multiple carbonated drink portions and then decoupled from the appliance or system and discarded. Accordingly, the container has a plug at its opening (the opening typically formed at end of a neck portion of the container) that is configured for (i) sealing the opening until use of the container, (ii) irreversibly opening, piercing or rupturing upon coupling of the opening with a coupling element (also referred to herein, occasionally, as “adapter”), which may be an integral element of the appliance or system or may be or a coupling device (an adapter) for coupling to the container's opening on the one hand and to the appliance or system on the other hand to thereby establish gas communication between the container and said appliance or system, and (iii) thereafter permitting the release of the pressurized gas from the container into a gas port of said appliance or system. The container's body may be formed with walls having an average thickness that is less than that of containers intended for repeated use, where the walls need to meet higher safety standards to withstand the many repeated cycles of filling the container with pressurized gas and subsequent emptying.

The mode of use of prior art pressurized gas containers that involves multiple filling and emptying cycles (“multiple use container”) mandates high safety standards, which include, among them, robust construction standards manifested, among others, in certain wall thickness requirements. In the case of a container of the kind provided by this disclosure, the container body may have walls with an average thickness that can be 60%, 55%, 50%, 45%, 40% or at times even less of the average thickness of the walls of a container body of a multiple use container. This may lead to a considerable saving in weight and costs.

Other aspects of this disclosure include:
a plug device that may be integrated with a container blank to form the pressurized gas container of this disclosure;
a container blank that may be integrated with said plug device to form the pressurized gas container of this disclosure;
a method for the preparation of such container, comprising filling the blank with pressurized gas and then sealing the opening of the container with the plug device;
an apparatus for such manufacture for carrying out said method;
an adapter for coupling a pressurized gas container to an appliance or system;
multipack of pressurized gas containers, which may also comprise such an adapter; and
an appliance or system for utilizing the pressurized gas containers of the invention, e.g. an appliance or system for preparing carbonated drink.

Thus, provided by an aspect of this disclosure is a pressurized gas container or canister (jointly referred to herein as “container”) in particular (but not exclusively), one containing pressurized carbon dioxide. The pressurized gas container of this disclosure may be configured for use in an appliance or system adapted for the preparation and optionally dispensing of carbonated drinks. The container is, typically, one that is intended for association with a carbonated drink dispensing appliance or system in which the pressurized carbon dioxide is utilized for the preparation of the carbonated drink. Thus, the pressurized gas container is intended for association with and supplying gas to a pressurized gas port of an appliance or system. Another example of container that may be employ the principles of the current disclosure is a container filled with pressurized air, oxygen or other breathing mixture for use by firemen, by high-altitude mountain climbers, as a bailout breathing canister for scuba divers; etc. The container comprises a container body, defining a pressurized gas enclosure, and a neck integral therewith that defines a gas outlet and is configured for coupling with a coupling element. The coupling element may be a coupling element integral with or forming part of said gas port or may be a coupling element of a coupling device or adapter configured for coupling with said port, to permit the release of gas into a pressurized gas port of said appliance or system. The term “coupling element” will be used to refer collectively to a coupling element which is integral with or part of an appliance or system and a stand-alone coupling device for coupling between a container and the appliance or system. The neck is fitted with a plug. The plug has a gas-impermeable barrier element sealing said enclosure and configured for irreversible opening through rupture, piercing, deformation or displacement (to be referred to, collectively, as “irreversible opening”) by a shaft of a gas channeling member of said coupling element that extends from a base to an end, which may be tapered or spiked. The plug also has one or more sealing elements, which are distinct from said barrier element, and are configured for forming a gas-tight association with said shaft to thereby block gas leakage after coupling.

Typically, in order to ensure that it will not be undesirably ruptured, deformed or displaced, the barrier element should be designed to withstand pressure higher than that of the intended gas pressure inside said enclosure. Furthermore, for safety reasons, the barrier element should be designed to have a defined burst threshold pressure that will cause the barrier element to burst open. This may avoid danger in the event of pressure build-up within the container, e.g. as a result of exposure to excessive heat.

By an embodiment of this disclosure, the plug in the pressurized gas container is formed with a bore that is fitted with a gas impermeable barrier element for forming a gas impermeable barrier between the pressurized gas enclosure and said bore. The barrier element can be non-reversibly opened by a shaft of a gas-channeling member, extending from a shaft base to a shaft end, the shaft end that penetrates the cavity during association of the neck with the coupling element, and during this penetration it causes the barrier element to irreversibly open. Once irreversibly opened, gas can flow past the now opened barrier element. The shaft end may be tapered, spiked or pointed, to facilitate rupturing or breaking of barrier. The bore, however, is also configured with at least one sealing element, typically one or more O-rings disposed proximal to the bore's exterior end or in between the barrier element and said exterior end, adapted for forming a gas-tight association with said spiked member, thereby hindering undesired gas leakage through said bore. The shaft of the gas-channeling member has one or more openings at a location proximal to its end such that, following complete penetration of said shaft and thereby causing the irreversible opening of the barrier element, are in gas communication with said enclosure; namely the opening are at the shaft's free end or in between said free end and the point of contact with said at least one sealing element. The openings lead into a gas-ducting lumen formed within the shaft that channels the gas into the pressurized gas sub-system of the appliance or system. Thus, once the barrier element is opened, the gas can flow through the openings and the gas-ducting lumen into the pressurized gas sub-system of the appliance or system for use therein.

By an embodiment of this disclosure, the barrier element is a pierceable solid element, e.g. a sheet, thin plate, film, etc. (to be referred to herein, collectively, as “pierceable element”), which may, for example, be made of metal or a plastic material. The pierceable element should be able to withstand pressure at least equal to (or slightly more than) the intended pressure of the gas inside the container.

By another embodiment, the barrier element is constituted by a displaceable or deformable plug or leaf, typically made of an elastic material, which is maintained in a sealing state pressed against a plug seat and may be irreversibly displaced or deformed by the gas channeling spike member.

By an embodiment of this disclosure, the plug is fitted into the container's neck, such that its bore is substantially coaxial (save for small manufacturing tolerance) with said neck. It should further be noted that this disclosure is certainly not limited to such coaxial configurations and the main features of this disclosure may also be embodied in other arrangements; for example, in a plug that is generally L-shaped with a cavity intended for coupling with a spiked member being normal to the axis defined by the neck.

By an embodiment of the current disclosure, the plug is formed as a device to be fitted within the neck of a container blank. Such a device is also an independent aspect of this disclosure. In the following the term “plug” may be used to denote, depending on the context, either a plug within the container's neck or a plug device that is fitted/intended to be fitted into the neck.

By an embodiment of this disclosure, the plug defines an axis extending between an exterior end and an internal end (e.g. having an overall cylindrical shape) and being formed with a generally axial bore extending between the two ends. Such plug is typically formed with a barrier at or proximal to its interior end and with one or more sealing elements formed within the cavity at or proximal to the exterior end or in-between the interior and exterior ends. The sealing elements, as already noted above, are typically O-rings that may be fitted within a circumferential groove formed within the wall of the cavity.

The plug may be formed with an uneven external surface (i.e. non-uniform profile) which may serve for tighter engagement with surrounding portions of the neck into which the plug device is fitted.

By one embodiment, the plug is pressure-fitted within the neck. This means that either the plug is inserted into the neck and the surrounding neck portion is then crimped over the side walls of the plug, or that a plug device is forcibly inserted into the neck thereby slightly deforming the upper end portion of the neck to ensure a pressure-tight fit. By another embodiment the plug is screw-fitted within the opening of the container. By yet another embodiment the plug is secured within the opening by welding. By still another embodiment the plug is secured within the opening by a combination of screw-fitting and welding, screw-fitting and pressure fitting or pressure fitting and welding.

The plug device, according to an embodiment of this disclosure, comprises external walls and a bore formed within it and includes a barrier element and at least one sealing element of the kind specified above.

By an embodiment of this disclosure the container comprises a flow-restricting element configured to permit (i) free flow of pressurized gas as long as the neck is coupled to the coupling element and (ii) limited outflow of gas upon decoupling of the coupling element from the neck. Thus, in the event that the container is detached from the coupling element of the system or appliance, the gas remaining in the container will not outflow in a rapid or violent burst but will rather be gradually released. The flow-restricting element may comprise a floating member (which may be rounded, e.g. ball-shaped) displaceable between a seated position in which it bears against a seat at an outlet of the container to thereby partially seal the container's outlet and an unseated position in which it is distanced from said seat and permitting free gas outflow through said outlet, said floating member being biased into said seated position and being configured for displacement into said unseated position by the shaft of said gas channeling member. The flow-restricting element is typically situated in a position interior to said barrier element and may comprise a nesting member fitted within the container's neck and having an upper segment defining said seat and a lower segment comprising arms configured to limit displacement of said floating member. In order to provide for a limited gas outflow, gas channels are typically defined in the flow-restricting element such that in the seated position of the floating member trickled gas outflow is enabled. By one configuration, such channels are defined in the seat. The floating element may be for a seal with the seat other than in portions in which such channels are defined. By another configuration the association between the floating member and the seat is such to permit some gas flow in a small gap between said member and said seat. For example, the seal or the member may have a rough surface to thereby define small gaps between the two to thereby permit trickled gas outflow. By yet another configuration channels are defined between the nesting member and the interior faces of the neck to facilitate gas outflow when the floating member is seated in said seat. The current disclosure also provides a multipack comprising (i) a holding rack, (ii) a carrying element, typically integral with the rack, and (iii) a plurality of pressurized gas containers, in particular, but not exclusive, a plurality of pressurized carbon dioxide-containing canisters, each of which is configured for coupling with said adapter (whether an integral part of an appliance or system or a coupling device), and once coupled, release gas into the pressurized gas port of the appliance or system. The holding rack may be configured as a case, box, etc., having a plurality of slots for holding the canisters and may be made of cardboard, plastic, or any other suitable material. The overall configuration of the multipack of this disclosure resembles that of multipacks for bottles or cans. The rack may also be configured for holding the containers in a hanging fashion. The containers in such multipacks are typically such intended for single use containers, e.g. of the kind disclosed herein. The multipack of this disclosure may also comprise a coupling device.

Another aspect of this disclosure is a method for the manufacture of a container that holds pressurized gas. The method is described with a certain sequence of steps, but it should be understood that while the sequence of steps may be carried out as described, certain steps may also be carried out in a different sequence or some steps may be carried out partially or fully in parallel. For example, described below is fitting of a plug device at the leading end of a plunger, which may be carried out before, simultaneously or after association of the container blank with the seat.

The method comprises providing a container blank, introducing pressurized gas through the open end of the neck portion, introducing a plug device into the neck and tightly affixing the plug within the neck. The container blank is of the kind configured to hold the pressurized gas and having a container body with an integral neck, the neck having an open end portion and at least said end portion being formable under defined conditions. After pressurized gas is introduced into the container, the plug device, which is of the kind specified above, is introduced into the open end while maintaining gas pressure. Once the plug device is inserted into the open neck, it is tightly affixed within the neck by applying said condition to thereby form the upper end to tightly engage the plug device's external faces. Such conditions may be a forced compression applied on the end portion of the neck about said device. Where the gas is carbon dioxide, a single use canister for the preparation of carbonated drink is, thus, obtained.

By one embodiment, the method comprises associating the container blank with a block in a gas tight manner, such that (i) the open end portion of the container's neck protrudes through an opening in the block into a working space that is linked to a source of pressurized gas, and that (ii) leakage of gas out of the opening is hindered; then permitting gas to flow from a gas source into the container via said working space; while maintaining gas pressure, inserting and tightly fixing the plug device in the open end of the neck. The tight fixing may be achieved through crimping the end portion of the neck about the plug device to thereby form tight engagement between the neck and side surfaces of the plug device.

Insertion of the plug typically comprises fitting the plug device at a leading end of a plunger, that can axially reciprocate along an axis defined by the neck, between a first plunger position and a second plunger position that is more proximal to said open end. After such fitting, the plunger is axially displaced into the second plunger position to thereby introduce the plug device into the neck's open end.

By another embodiment of the method, the plunger axially reciprocates within an axial bore that is formed in a piston. The piston can also axially reciprocate along the same axis between a first piston position and a second piston position that is more proximal to the neck's open end. In accordance with this embodiment, the tight affixing of the plug device within the neck is carried out while maintaining the plunger in the second plunger position and axially displacing the piston to its second piston position, in which it applies a crimping-biasing force on the neck's upper end to thereby crimp it about the plug device. The piston may comprise a depression formed in the piston's face that faces the neck, in a mid-portion thereof that surrounds said bore (in which the plunger reciprocates). In the second piston position, the depression bears on the upper end of the neck and the overall concave shape of the depression then guides an inward crimping of the necks upper end about the plug device. The depression is typically circular in its perimeter and its dimension corresponds to that of the neck's upper end.

As will be appreciated, depending on the intended manner of securing the plug within the opening of the container's neck, additional or alternative steps for such securing may be added, such as rotational insertion of the plug in the case of screw-fitting or a welding step in one of a variety of welding techniques known per se.

Also provided by this disclosure is an apparatus for producing a container of the kind specified herein. The apparatus comprises a block, a pressurized gas conduit and a piston with a plunger. The block defines a working space with axially extending side walls and a base. The pressurized gas conduit leads into said working space and is linked to a pressurized gas source. The piston is received within said working space, forming a gas-tight association with the side walls and is capable of axial reciprocation within the working space between the first piston position and the second piston position more proximal to the said base. An axial bore is formed in said piston and accommodates a plunger. The plunger forms a gas-tight association with the bore's walls and the association is such to permit axial reciprocation of the plunger within the bore, between said first plunger position and said second plunger position which is proximal to said base. The base has an opening that is formed at the end of a seat configured for receiving an upper portion of the container blank, and for forming a gas-tight association therewith; with the upper, open end of the neck protruding through the opening into said working space. The plunger has a leading end and is configured for holding a plug device of the kind specified herein and for introducing the plug device into the upper end of the neck when in the second plunger position. The piston is adapted for applying a crimping-biasing force on the upper end of the neck to thereby crimp said upper end about external faces of said plug device. The piston may have a depression to serve this purpose, of the kind specified above.

The apparatus that may be configured to operate in an operational mode that comprises: associating the upper end of the container with the seat; introducing pressurized gas into the container via the working space; axially displacing the plunger fitted with said plug device into the second plunger position to thereby introduce the device into said open end; and, while maintaining the plunger in said second plunger position, axially displacing the piston to the second piston position in which it applies a crimping-biasing force on the neck's upper end, to thereby crimp it.

The apparatus may be modified, in an analogous manner to that described above in reference to the process, to accommodate additional or alternative means for securing the plug with the container's neck.

Also provided by this disclosure is a container blank with a body and neck integral therewith having an open end; the body is configured for holding pressurized gas; the neck is adapted to receive a plug device of the kind specified. The open end may be formable under defined conditions, e.g. by pressure forming. The container blank is usually made entirely of the same material, which may be metal, e.g. aluminum.

This disclosure provides, by another of its aspects, a coupling element for coupling a gas container, particularly of the kind disclosed herein, to an appliance or system in a manner so as to permit gas supply from the container to a gas conduit of an appliance or system; for example, carbon dioxide appliance or system for the preparation of the carbonated drink. The element comprises a gas channeling member that has an elongated shaft extending axially from a base thereof to a shaft end. The shaft is configured for fitting into a bore of the plug opening in the container and further configured so that, once coupled with the container, it causes irreversible opening of a barrier element that is formed at the inner end of said bore. The shaft has openings at, or proximal to, the shaft end leading into said conduit. The coupling element of this aspect may, by one embodiment, be an element that is formed as a part of said appliance or system. By another embodiment, such an element is an independent coupling device for coupling the container to a gas port of an appliance or system.

By an embodiment of the latter aspect, the coupling element also defines one or more gas-release channels, configured to form, during decoupling of the container and the coupling element, a gas-release conduit between the container's interior and the exterior. The purpose of such gas-release conduit is to enable slow or controlled release of gas from the container's interior, in the event that gas pressure remains within the container prior to such decoupling. This may be a stand-alone controlled release feature or one that functions in conjunction with a mechanism that is an integral part of the container, as described above. This, as noted above, is intended to avoid a violent or abrupt release of pressure upon decoupling.

The gas-release conduit may, by one embodiment, be constituted by one or more axial grooves or recesses formed on the shaft's face that faces the bore's internal wall. In this latter embodiment, the conduit is defined between the shaft and the bore's internal walls.

Provided by another aspect of this disclosure is a coupling device for coupling a pressurized gas container to a pressurized gas port of an appliance or system. The device is configured for coupling to the container's opening, at its first end, and for coupling to a fitting fitment of a gas port of the appliance or system, at its second end. The term “coupling” used herein in connection with the device is intended to denote that the two coupled elements are functionally linked.

Defined within said coupling device is a gas conduit that once the device is so coupled establishes a gas-flow channel from the container's opening to the gas port of said appliance or system. Said first end comprises a gas channeling member that has an elongated shaft that extends from a base to a shaft end. The shaft is configured (e.g. in terms of position and dimension) to penetrate the bore of the plug that is disposed in the opening of the container during coupling of the container to said one end to thereby cause an irreversible opening of the barrier element formed at the inner end of said bore. The shaft has openings at or proximal to the shaft end leading into said gas transfer channel, e.g. leading into a lumen formed within the shaft that is linked to said channel.

By one embodiment the coupling device comprises a cup-shaped connector portion at its first end, the connector having an end wall and side walls extending therefrom and being configured for coupling with a neck portion of the pressurized gas container. According to this embodiment the gas channeling member extends within the cup-shaped connector from a base in said end wall. The internal side walls of the connector are, typically screw-threaded and the coupling is then through a screw-type engagement with an external threading on said neck portion. Said cup-shaped connector portion has a ring at its end fitted to the connector portion in a screw-type engagement and serving for fastening the device to said neck portion after coupling.

The coupling device may comprise an outlet valve at the second end configured for sealing the gas outlet of said gas conduit at said second end and for opening upon coupling of said second end to the appliance or system to permit gas egress into the gas-ducting system of said appliance or system. The device may also comprise a safety plug adapted to discharge gas when the pressure within gas transfer channel exceeds a predetermined level.

Once the coupling device is coupled to the pressurized gas container, at its first end, the barrier is opened or ruptured, whereupon gas is free to flow out of the container, the sealing arrangement described above ensures that no gas would leak to the surrounding environment. However, should the device be accidentally decoupled from the container, there is a risk of an abrupt pressurized gas egress from the container to the external environment which, under some circumstances, may be hazardous. Thus, in order to avoid such abrupt gas release, by an embodiment of this disclosure, a safety feature is provided to block unintended decoupling of the coupling device from the pressurized gas container, as long as pressure within the container exceeds the predetermined level, e.g. a level defined by safety standards as being safe. The safety feature includes a safety arrangement which is configured for locking the coupling device onto the container's neck, as long as the gas pressure within the container exceeds said predetermined pressure level. This may be achieved, by an embodiment of this disclosure, by a safety bolt that is configured to lock the coupling device in a coupled state as long as the pressure within the container exceeds said predetermined pressure level. By way of example, such bolt may be maintained in a locked state by a pin that engages with the safety bolt and that is kept in such an engaging state by the gas pressure; and once the gas pressure reduces to a level below said predetermined level, the pin can disengage the bolt, which is thereby released to permit decoupling of the device from the container.

The term “bolt” should be understood to encompass any functional element that can induce such locking.

A coupling device according to an embodiment of this disclosure with a safety arrangement comprises a safety locking element, e.g. a safety bolt configured for fitting into a recess or groove formed in the container's neck to block accidental decoupling of the device from the container. The safety bolt may be configured for displacement, e.g. linearly, between a first, locking bolt position in which it fits into said recess (and thereby blocks decoupling) and a second, releasing bolt position in which it is removed from said recess. The arrangement is typically such that the safety bolt is biased into the second bolt position by an associated urging element and locked in the first position by an associated locking arrangement adapted to (i) lock the bolt in the first bolt position as long as decoupling of the coupling device from the container is to be avoided (namely as long as the gas pressure within the container exceeds said predetermined level), and (ii) release the bolt once the pressure in the container is reduced to a safe pressure level, namely below said predetermined level. Locking of the safety bolt in said locking position and releasing it once the pressure in the container is reduced to a safe level may be achieved by a variety of means.

By one embodiment the locking arrangement comprises a locking pin that can reciprocate between a locking state in which it engages the safety bolt and locks it in the first bolt position, and a releasing state in which the pin is disengaged from the bolt which can, thus, be displaced into the second bolt position. The locking pin is typically biased into the releasing state by an associated urging element, e.g. a spring, and is forced into the locking state (against this biasing force of the urging element) by the gas pressure within the container, as long as the gas pressure exceeds said predetermined pressure level. The locking pin may, for example, reciprocate in a pin bore that is in gas communication with the gas conduit and is, thus, pushed by the gas pressure, against the biasing force of its associated urging elements. For this, the locking pin can have shoulders that form a gas-tight seal with the pin bore's wall such that gas pressure acting on said shoulders forces the pin into the locking state. The pin-associated element imparts an urging force on the locking pin such that it will exceed the force applied by the gas pressure when the pressure level is reduced below said predetermined pressure level to thereby cause its displacement to the releasing states.

The safety bolt may be forced into the first bolt state as part of the coupling action. For example, the device may comprise a locking ring that can rotatably reciprocate between a locking state in which it causes the safety bolt to displace into the first bolt position and an unlocking state in which it permits displacement of the safety bolt into the second bolt position. The arrangement is typically such the locking ring's rotation occurs as part of the coupling action. For example, the ring may be associated with a biasing element that urges it into the locking state and upon coupling it rotates to its locking state thus forcing the bolt into the recess or groove in the container's neck. The piercing of the barrier element permits the pressurized gas to enter the gas conduit within the coupling device thereby locking the bolt in the first, safety bolt position.

Further provided by this disclosure is an appliance adapted for preparing or dispensing carbonated drink. Such appliance or system may be intended only for the preparation of carbonated drinks or intended for the preparation of carbonated as well as other drinks. The appliance or system comprises a coupling element for coupling with a carbon dioxide containing canister and for receiving the pressurized carbon dioxide therefrom. The coupling element comprises a coupling element for coupling with the end portion of the neck and comprises a gas-channeling member with a spiked end. The canister is of the kind specified above and upon coupling of the neck with the coupling element the gas-channeling member ruptures the barrier element to permit channeling of carbon dioxide from the container to the appliance, while the sealing member maintains gas-tight association with said member to avoid gas leakage.

### EMBODIMENTS

The present disclosure also encompasses embodiment as defined in the following numbered phrases. It should be noted that these numbered embodiments intended to add to this disclosure and is not intended in any way to be limiting. Note also that although the term “embodiment” is used in a singular form also where a phrase references a previous phrase that in fact relates to many embodiments (for example phrase No. 47 that refers back to phrase No. 46, where the latter relates to several embodiments), such a numbered phrase (e.g. No. 47) is intended to encompass all the embodiments that are encompassed by the embodiment to which it refers, with the added element of defined in a such a referencing numbered phrase.

1. A pressurized gas container for association with and supplying gas to a pressurized gas port of an appliance or system, the container comprising:

a container body, defining a pressurized gas enclosure, and a neck integral therewith defining a gas outlet;

the neck
having an end portion that is configured for coupling with a coupling element, which may be a coupling element integral with or forming part of said gas port or may be a coupling element of a coupling device or adapter configured for coupling with said port, and being
fitted with a plug;

the plug having
a barrier element sealing said enclosure and configured for non-reversible rupturing by a shaft of a gas-channeling member of said coupling element, and having
one or more sealing elements, distinct from said barrier element and configured for forming a gas-tight association with said shaft.
   2. The container of embodiment 1, wherein

the pressurized gas within the container is pressurized carbon dioxide, and is intended for association with a carbonated drink dispensing appliance or system in which the pressurized carbon dioxide is utilized for the preparation of the carbonated drink.

3. The container of embodiment 2, wherein the container is configured for association with said appliance or system such that the pressurized carbon dioxide for the preparation of the carbonated drink is drawn when needed out of the container.
4. A pressurized gas container for association with and supplying gas into a pressurized gas port of the appliance or system, the container comprising:

a container body, defining a pressurized gas enclosure and a neck integral therewith defining a gas outlet;

the neck
having an end portion that is configured for coupling with a coupling element of the kind defined in embodiment 1 and is fitted with a plug;

the plug being formed with a bore that is fitted with a barrier element (within or at end of the bore) that forms a gas impermeable barrier that seals said enclosure,

said barrier element being rupturable or pierceable by a shaft of a gas-channeling member of said coupling element, and

said bore being configured with at least one sealing element for forming a gas-tight association with said shaft.

5. The container of any one of embodiments 14, wherein the gas is carbon dioxide and the appliance or system is adapted for the preparation of a carbonated drink.
6. The container of any one of the preceding embodiments, wherein said barrier element is a pierceable metal sheet.
7. The container of embodiment 4, wherein said sheet is configured for rupturing in the event that the pressure within the container exceeds a predefined threshold.
8. The container of any one of the preceding embodiments, wherein said plug is fitted into the container's neck such that said bore is substantially co-axial with said neck.
9. The container of any one of the preceding embodiments, wherein said plug defines an axis extending between an exterior end and an interior end (e.g. having an overall cylindrical shape) and being formed with a generally axial bore extending between the two ends.
10. The container of embodiment 9, wherein said barrier is formed at said interior end of the bore and said one or more sealing elements are formed within said bore at said exterior end or in between said interior and said exterior end.
11. The container of embodiment 10, wherein the one or more sealing elements are one or more O-rings.
12. The container of embodiment 11, wherein said O-ring is fitted within a circumferential groove formed in the walls of said bore.
13. The container of embodiment 8, wherein the plug is formed with an uneven external surface.
14. The container of any one of the preceding embodiments, wherein said plug is fitted within said neck.
15. The container of embodiment 14, wherein the plug is pressure fitted within said neck.
16. The container of any one of the preceding embodiments, wherein said body has an average wall thickness that is less than 60%, 55%, 50%, 45% or even less that 40% of the average wall thickness of a container of similar dimensions an made of similar material that is intended for multiple use.
17. The container of any one of the preceding embodiments, comprising a flow-restricting element configured to permit (i) free flow of pressurized gas as long as the neck is coupled to the coupling element and (ii) gradual outflow of gas upon decoupling of the coupling element from the neck.
18. The container of embodiment 17, wherein the flow-restricting element comprises a floating member displaceable between a seated position in which it bears against a seat at an outlet of the container to thereby partially seal the container's outlet and an unseated position in which it is distanced from said seat and permitting free gas outflow through said outlet, said floating member being biased, e.g. by gas outflow or by an associated biasing element (such as a spring), into said seated position and being configured for displacement into said unseated position by the shaft of said gas channeling member.
19. The container of embodiment 18, wherein said floating member is rounded, e.g. spherical.
20. The container of embodiment 18 or 19, wherein said flow-restricting element is situated in a position interior to said barrier element.
21. The container of embodiment 20, wherein said flow-restricting element comprises a nesting member fitted within the container's neck and having an upper segment defining said seat and a lower segment comprising arms configured to limit displacement of said floating member.
22. The container of embodiment 21, wherein the seat defines flow channels.
23. The container of embodiment 21, wherein flow channels are defined between the seat and the neck's interior face.
24. A multipack comprising

a holder rack;

a carrying element; and

a plurality of pressurized gas containers, e.g. a plurality of pressurized carbon dioxide-containing canisters.

25. The multipack of embodiment 24, wherein the rack is configured as a case, a box or multipack rings.
26. The multipack of embodiment 25, wherein said holding rack is integral with the carrying element.
27. The multipack of any one of embodiments 24-26, wherein the containers are intended for single use.
28. The multipack of any one of embodiments 24-27, wherein the containers are those defined in any one of embodiments 1-23.
29. A plug device for integration in a container of any one of embodiments 1-23.
30. A plug device for integration into a neck of a pressurized gas container blank, the plug comprising

a bore extending through the plug;

a barrier element fitted in the bore (at an end of or within said bore) and configured for non-reversible rupturing by a shaft of a gas-channeling member of an adapter of an appliance or system; and

one or more sealing elements within said bore, distinct from said barrier element and configured for forming a gas-tight association with said shaft.

31. The plug device of embodiment 30, being formed with a bore that is fitted with a barrier element that once the device is integrated into said neck forms a gas impermeable barrier sealing said bore from a pressurized gas enclosure within said container.
32. The plug device of embodiment 30 or 31, wherein said barrier element is a pierceable metal sheet.
33. The plug device of embodiment 32, wherein said barrier element is configured for rupturing in the event that the pressure differential between its internal face that in use faces the container's pressurized gas enclosure and its external face exceeds a predefined threshold.
34. The plug device of any one of embodiments 30-33, wherein said plug is configured for fitting into the container's neck such said bore is substantially co-axial with said neck.
35. The plug device of any one of embodiments 30-34, having an overall cylindrical shape with an exterior end and an interior end and an axial bore extending therebetween.
36. The plug device of embodiment 35, wherein said barrier is formed at said interior end and said one or more sealing elements are formed within said bore at said exterior end or in between said interior and said exterior end.
37. The plug device of embodiment 36, wherein the one or more sealing elements are one or more O-rings.
38. The plug device of embodiment 37, wherein said O-ring is fitted within a circumferential groove formed in the walls of said bore.
39. The plug device of embodiment 38, wherein the plug is formed with an uneven (non-uniform) external surface.
40. The plug of any one of embodiments 30-39, for fitting within said neck.
41. The plug device of embodiment 40, wherein the plug is configured for pressure fitting within said neck.

In the following methods defined in the independent statements or in dependent ones, the sequence of steps may be as specified or may be a different sequence. Also, some of the specified method steps may also fully or partially overlap other steps, i.e. may be carried out fully or partially in parallel to one another.

42. A method for the manufacture of a container with a pressurized gas, comprising:

(a) providing a container blank configured to hold pressurized gas, the container blank having a container body, defining a pressurized gas enclosure, and a neck at its upper end, the neck having an upper, open end portion, at least said upper end portion being formable under defined conditions;

(b) introducing pressurized gas into said enclosure through said open end;

(c) while maintaining gas pressure, introducing a plug device into said open end, the plug device comprising external side walls and a bore formed within it, the bore being fitted with a barrier element configured for non-reversible rupturing by a shaft of a gas-channeling member of coupling element of a device or system, and comprising one or more sealing elements within said bore distinct from said barrier element and configured for forming a gas-tight association with said member; and

(d) tightly affixing said plug device within said neck by forming said upper end to tightly engage the plug device's external faces.

43. The method of embodiment 42, wherein said upper end of the neck is made of metal and said forming is a pressure-forming.
44. The method of embodiment 42 or 43, wherein the container blank is made entirely of the same material.
45. The method of embodiment 44, wherein the container is made of metal, e.g. aluminum.
46. The method of any one of embodiments 42-45, wherein the gas is carbon dioxide.
47. The method of embodiment 46, for the manufacture of a pressurized gas canister for association with an appliance or system adapted for the preparation of a carbonated drink.
48. The method of any one of embodiments 45-47, comprising:

(m) associating the container blank with a block in a gas tight manner such that (i) the open end of the container's neck protrudes through an opening in the block into a working space that is linked to a source of pressurized gas, and that (ii) leakage of gas out of the opening is hindered;

(n) permitting flow of gas from the gas source into the container via said working space;

(o) while maintaining gas pressure, inserting said plug device into said open end; and

(p) tightly affixing said plug device within said neck, e.g. by crimping said upper end to tightly engage said side surfaces.

49. The method of embodiment 48, wherein step (o) comprises:

(o1) fitting said plug device at a leading end of a plunger that can axially reciprocate along an axis defined by said neck between a first plunger position and a second plunger position that is more proximal to said open end, and

(o2) axially displacing said plunger into the second plunger position to thereby insert the plug device into said neck.

50. The method of embodiment 49, wherein:

said plunger axially reciprocates within an axial bore formed in a piston;

the piston can axially reciprocate along said axis between a first piston position and a second piston position that is more proximal to said open end; and wherein step (p) comprises

while maintaining the plunger is said second plunger position, axially displacing said piston to said second piston position in which it applies a crimping-biasing force on said upper end to thereby crimp said upper end.

51. The method of embodiment 50, wherein

the piston comprises a depression in the piston's face that faces said neck in a mid-portion thereof that surrounds said bore; and wherein

in said second piston position the depression bears on said upper end of the neck and such bearing applies said crimping-biasing force.

52. The method of embodiment 51, wherein

said depression is circular and its perimeter is dimensioned to correspond to that of said upper end.

53. An apparatus for producing a container having a container body and a neck integral therewith that is fitted with a plug, the apparatus comprising:

a block defining a working space with axially extending side walls and with a base;

a pressurized gas conduit leading into said working space and linked to a pressurized gas source;

a piston, received in said working space and forming a gas-tight association with said side walls, the piston being capable of axial reciprocation within the working space between a first piston position and a second piston position that is more proximal to said base;

an axial bore formed in said piston and a plunger that is accommodated in said bore, forms a gas-tight association with bore's walls and that can axially reciprocate within said bore between a first plunger position and a second plunger position that is more proximal to said base;

the base having an opening formed at the end of a seat, the seat being configured for receiving an upper end of a container blank and for forming a gas-tight association therewith, with the upper end of the neck protruding through the opening into said working space;

the plunger having a leading end configured for holding a plug device as defined in any one of embodiments 29-41 and for introducing the plug device into the upper end of the neck when in the second plunger position;

the piston being adapted for applying a crimping-biasing force on said upper end to thereby crimp said upper end on external faces of said plug device.

54. The apparatus of embodiment 53, wherein

the piston comprises a depression formed in the piston's face that faces said neck in a mid-portion thereof that surrounds said bore; and wherein

in said second piston position the depression bears on said upper end of the neck and such bearing applies said crimping-biasing force.

55. The apparatus of embodiment 53 or 54, configured for operating in an operational sequence that comprises

(a) associating the upper end of the container with the seat;

(b) introducing pressurized gas into the container via said working space;

(c) axially displacing the plunger fitted with said plug device into the second plunger position to thereby introduce the device into said open end; and

(d) while maintaining the plunger is said second plunger position, axially displacing said piston to said second piston position in which it applies a crimping-biasing force on said upper end to thereby crimp said upper end.

56. A container blank with a body and a neck integral therewith and having an upper, open end, wherein

the body is configured for holding pressurized gas;

the neck is adapted to receive a plug device as defined in any one of embodiments 29-41; and

said upper end being formable under defined conditions.

57. The container blank of embodiment 56, wherein said upper end is formable by pressure forming.
58. The container blank of embodiment 56 or 57, made of metal, e.g. of aluminum.
59. The container blank of any one of embodiments 56-58, for use in the production of a container of any one of embodiments 1-23.
60. A coupling element for coupling a pressurized gas container to an appliance or system to permit gas supply to a gas conduit system of the appliance or system, the element comprising a gas channeling member having an elongated shaft that extends axially from a base to a shaft end, the shaft being configured for fitting into a bore of a plug in the opening of the container and, once coupled with the container, causes irreversible opening of a barrier element formed at an inner end of said bore; the shaft having openings at or proximal to the shaft end leading into said gas conduit.
61. The element of embodiment 60, defining also one or more gas release channels that are configured to form a gas-release conduit between the container's interior and the exterior during decoupling of the container and the coupling element.
62. The element of embodiment 61, wherein such gas-release conduit being constituted by one or more axial grooves or recesses at the shaft's peripheral face that faces the bore's internal walls.
63. The element of any one of embodiments 60-62, being an element of said appliance or system.
64. The element of any one of embodiments 60-62, being an independent device for coupling the container to a gas port of the appliance or system.
65. The device of embodiment 64, for coupling a pressurized gas container to a gas port of an appliance or system, wherein:

the device is configured for coupling to the container's opening, at its first end, and for coupling to a gas port of appliance or system, at its other end, and defined within it is a gas conduit that once so coupled channels gas from the container's opening to the gas port of said appliance or system;

said first end comprises a gas channeling member having an elongated shaft that extends from a base to a shaft end, the shaft being configured for fitting into a bore of a plug in the opening of the container and, once coupled with the container, causes irreversible opening of a barrier element formed at an inner end of said bore; and

the shaft having openings at or proximal to the shaft end leading into said gas conduit.

66. The device of embodiment 65, wherein

said first end comprises a cup-shaped connector portion with an end wall and side walls that is configured for coupling with a neck portion of the pressurized gas container, and

said gas channeling member extends from a base in said end wall within the cup-shaped connector portion.

67. The device of embodiment 66, wherein said side walls are internally screw-threaded and the coupling is through a screw-type engagement with an external threading on said neck portion.
68. The device of any one of embodiments 65-67, wherein said second end comprises a valve configured for sealing the gas outlet at said second end and for opening upon coupling of said second end to the appliance or system to permit gas egress into the gas port of said appliance or system.
69. The device of any one of embodiments 65-68, wherein said second end is externally screw-threaded for coupling to a matching fitment in said appliance or system.
70. The device of any one of embodiments 65-69, wherein said cup-shaped connector portion has a ring at its first end fitted to the connector portion in a screw-type engagement and serving for fastening the device to said neck portion after coupling.
71. The device of any one of embodiments 65-70, comprising a safety plug adapted to discharge gas when the pressure within gas transfer channel exceeds a predetermined level.
72. The device of any one of embodiments 65-72, comprising a safety arrangement configured for locking the device onto the container's neck as long as the gas pressure within the container exceeds a predetermined pressure.
73. A device for coupling a pressurized gas container to a gas port of an appliance or system, comprising:

a body having a cup-shaped connector with and end wall and side walls at its first end that is configured for coupling to a neck of the gas container's, and having a fitting arrangement at its second end for coupling to a fitment of a gas port of an appliance or system;

a gas channeling member having an elongated shaft with a lumen and extending from a base in said end wall to a shaft end, the shaft end having openings into said lumen; the shaft being configured for fitting into a bore of a plug in the opening of the container and, once coupled with the container, causes irreversible opening of a barrier element formed at an inner end of said bore;

a gas conduit formed within said body and linking said lumen with a gas outlet at said second end;

an outlet valve for sealing said gas outlet and for opening the outlet upon coupling of said second end to the appliance or system to permit gas egress into said gas port; and

a safety bolt configured for fitting into a recess or groove formed in the container's neck to block accidental decoupling of the device from the container.

74. The device of embodiment 73, wherein

said safety bolt can be displaced between a first bolt position in which it engages, e.g. fits into said recess or groove, and a second bolt position in which it is removed from said recess.

75. The device of embodiment 74, wherein

the safety bolt is biased into said second bolt position, e.g. by an associated urging element.

76. The device of embodiment 75, wherein

the safety bolt is locked in the first bolt position by an associated locking arrangement that is adapted to (i) lock the bolt in said first position as long as the gas pressure within said container exceeds a predetermined pressure, and (ii) release the bolt once the pressure in the container is reduced to a pressure level that is below said predetermined level.

77. The device of embodiment 76, wherein the locking arrangement comprises a locking pin that

can reciprocate between a locking state in which it engages the bolt and locks it in the first bolt position and a releasing state in which pin disengages the bolt to permit it to be displaced into the second bolt position;

is biased into the releasing state by an urging element; and

is forced into the locking state against the biasing force of the urging element by the gas pressure within the container as long as said pressure exceeds a predetermined pressure.

78. The device of embodiment 77, wherein the pin

reciprocates in a pin bore that is in gas communication with the gas conduit, and

the pin has shoulders that form a gas-tight seal with the pin bore's wall such that gas pressure on said shoulders forces the pin into the blocking state.

79. The device of embodiment 78, wherein a head space above said shoulders is in gas communication with said gas conduit.
80. The device of any one of embodiments 73-79, comprising a locking ring that can rotatably reciprocate between a locking state in which it forces the bolt into the first bolt position and an unlocking state in which it permits displacement of the bolt into the second bolt position.
81. The device of embodiment 76, wherein the ring is associated with by a biasing element that urges it into its locking state.
82. The device of any one of embodiments 64-81 for associating with the carbon dioxide container of any one of embodiments 1-23 or a container fitted with a plug device of any one of embodiments 29-41.
82. An appliance adapted for preparing or dispensing carbonated drink, the appliance comprising an adapter for associating with a pressurized carbon dioxide-containing canister and for receiving the pressurized carbon dioxide therefrom; wherein

said adapter comprises a coupling element and a gas channeling member having an elongated shaft that extends from a base to a shaft end, the shaft being configured for fitting into a bore of a plug in the opening of the canister and, once coupled with the canister, causes irreversible opening of a barrier element formed at an inner end of said bore;

the canister comprises a canister body and a neck integral therewith at its upper end fitted with the plug, the plug having a barrier element configured for non-reversible rupturing by said gas-channeling member and having one or more sealing elements, distinct from said barrier element, and configured for forming a gas-tight association with said member; and wherein

upon coupling of said neck with said adapter said gas-channeling member ruptures said barrier element to permit channeling of pressurized carbon dioxide from the container to the appliance while the sealing member maintains a gas-tight association with said member to avoid gas leakage.

83. The device of embodiment 82 for associating with a carbon dioxide container according to any one of embodiments 1-23 or a container fitted with a plug device of any one of embodiments 29-41.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 shows a schematic cross-section representation through a canister of the invention, typically one that contains pressurized carbon dioxide.

FIG. 2 is an enlarged schematic cross-section representation of the upper portion including the neck of the canister.

FIGS. 3A-3F are schematic cross-sectional representations of some operational parts of the apparatus used for the manufacture of a canister of the kind shown in FIGS. 1 and 2 in several successive manufacturing sequences.

FIGS. 4A-4C are schematic cross-sectional representations through the upper portion of a canister and a coupling element that is part of an appliance or system, e.g. such used for preparation of a carbonated drink, illustrating several successive sequences of coupling of the canister with the coupling element.

FIGS. 5A-9B are schematic representations of some embodiments of plugs that may be fitted into a cavity within the neck portion of a canister blank to form a canister of this disclosure. FIGS. 5A, 5C, 6A, 7A and 8A show an exploded view of the upper portion of the canister blank and the plug; while FIGS. 5B, 6B, 7B and 8B are respective longitudinal cross-sectional views of the upper portion of the canister with the plug fitted within the cavity in the neck portion. FIG. 9A is an exploded view of a plug in isolation and FIG. 9B is a longitudinal section of such a plug.

FIG. 10A is a longitudinal cross-section through (i) the neck of a canister that comprises a flow-restricting element in accordance with an embodiment of this disclosure and (ii) through a gas-channeling member of an appliance or system (the appliance or system, not shown), the canister and said member being separated from one another prior to coupling.

FIG. 10B shows the canister of FIG. 10A and the gas-channeling member coupled to one another.

FIG. 10C is a side view of the nesting member of the flow-restricting element.

FIG. 10D is a cross-section through lines C-C in FIG. 10C.

FIGS. 11A and 11B are, respectively, schematic exploded view and a cross-sectional view of a coupling device for coupling a pressurized gas canister to an appliance or system.

FIGS. 12A and 12B are, respectively, schematic perspective view and longitudinal cross-sectional view of the coupling device of FIGS. 11A and 11B coupled to a canister.

FIG. 13 is an exploded view of a coupling device according to another embodiment incorporating a safety arrangement against premature decoupling of the device from the pressurized gas canister.

FIGS. 14A and 14B are, respectively, longitudinal cross-sections along respective planes A-A and B-B, marked in FIG. 13.

FIGS. 15A and 15B are side elevation and longitudinal cross-section, respectively, of a pressurized gas canister coupled with a the coupling device of FIGS. 13-14B.

FIGS. 16A-16C are longitudinal cross-sections through the canister's neck and a coupling element with a shaft with defined gas-release conduits in a state of coupling (FIG. 16A), during decoupling (FIG. 16B) and being totally decoupled (FIG. 16C).

FIGS. 17A and 17B show two examples of multipacks (6-pack in this example) of canisters of the kind described herein.

### DETAILED DESCRIPTION OF EMBODIMENTS

In the following, the present disclosure will be elaborated and illustrated through description of some specific embodiments with reference to the annexed drawings. The illustrated embodiments refer to a canister, such as that containing carbon dioxide for use in an appliance or system for preparation of a carbonated drink. It is to be understood that the figures are intended to exemplify the general principles of this disclosure and are not to be construed in any way to be limiting.

The description of canister below makes occasional reference to a top or bottom. This is done for convenience of description only. As can be appreciated in use the orientation has no functional significance and it may be coupled to the appliance or system in any desired orientation according to various engineering or other considerations.

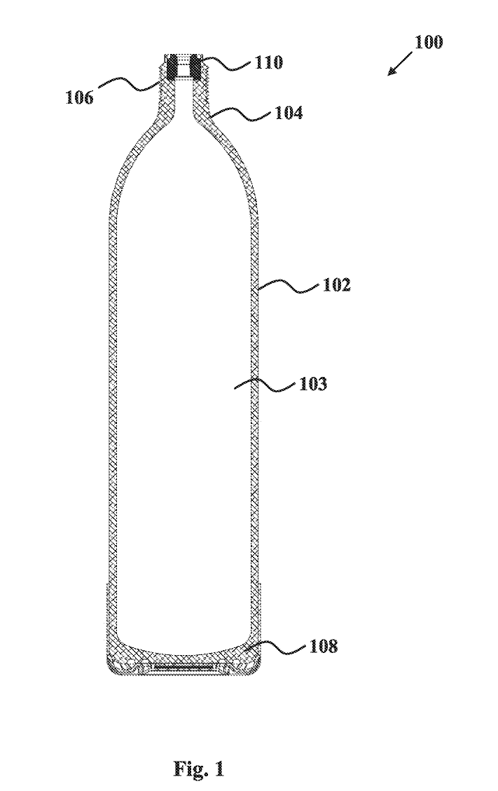

Referring first to FIG. 1, shown is a canister 100 having a body 102, defining a pressurized gas enclosure 103, and having an integral neck 104 with an external threading 106 for coupling to a coupling element of an appliance or system adapted, in this specific example, for the preparation of a carbonated drink. It should be noted that coupling by threading is only one example and other types of coupling are possible, such as for example snap-fitting. The canister may be made from a variety of different materials, a typical example being metal, such as aluminum. Fitted at the canister's bottom end is a base element 108, typically made of plastic serving as a base on which the canister may stand. Included within the neck is a plug 110.

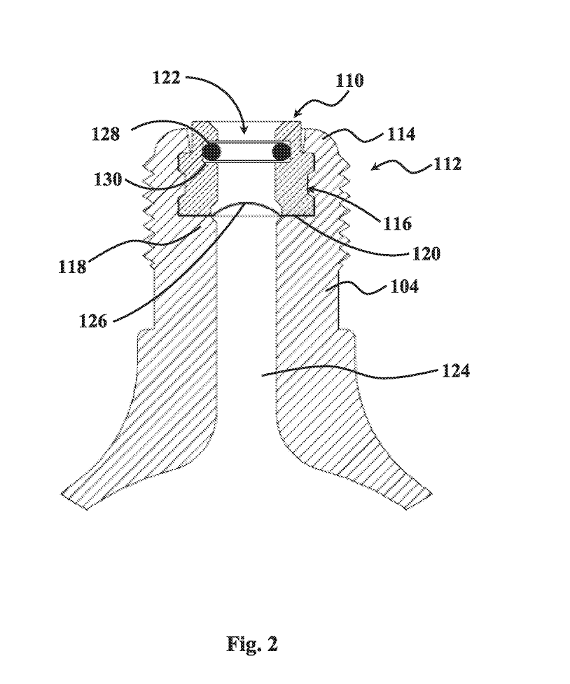

The upper portion of the canister including neck 104 is shown in FIG. 2. Particularly, what can be seen in more detail is plug 110 that is fitted at the upper part of the neck and is tightly secured in position by crimping of the upper portion 112 and particularly the upper lips 114, e.g. in a manner as will be described below. As can be seen, the plug device 110 has an external uneven surface 116 that provides for tighter engagement with the surrounding parts of the neck. As can also be seen, the bore within the upper end portion of the neck is of a larger diameter, defining a shoulder 118 that seats the bottom end 120 of the device.

The device 110 includes a bore 122 which is coaxial with bore 124 within neck 104. Formed at the bottom end of plug 110 is a barrier element 126 which is constituted by a metal sheet that seals enclosure 103. The plug also includes a sealing member which is constituted by an O-ring 128 that is accommodated within a circumferential groove 130 formed within the internal walls of bore 122.

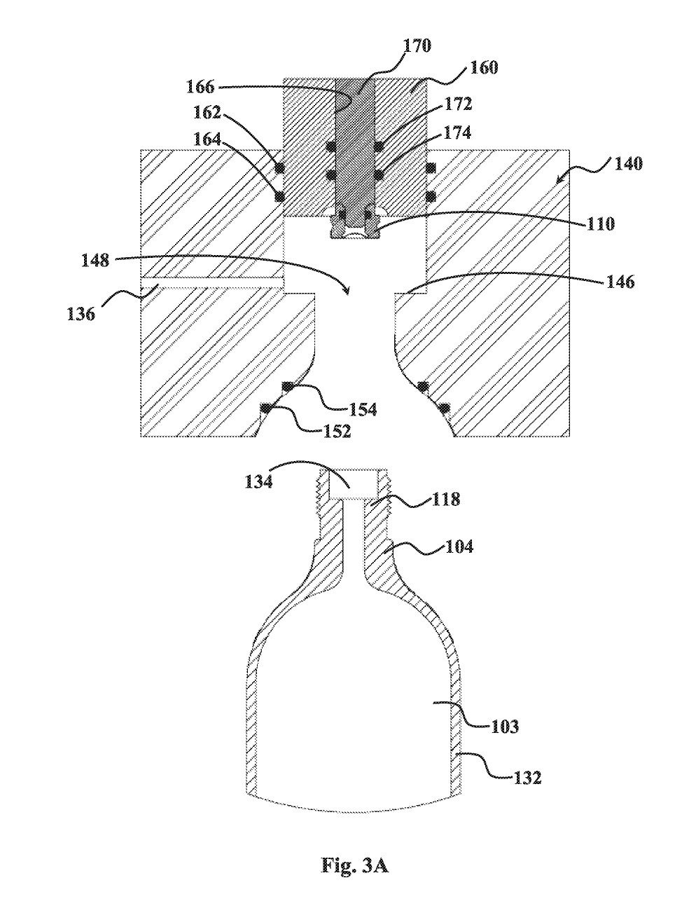

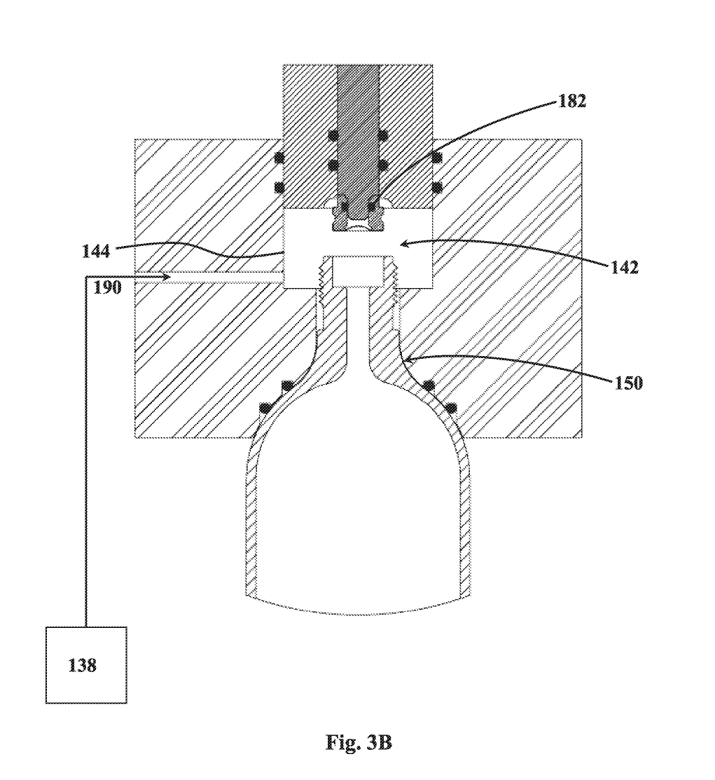

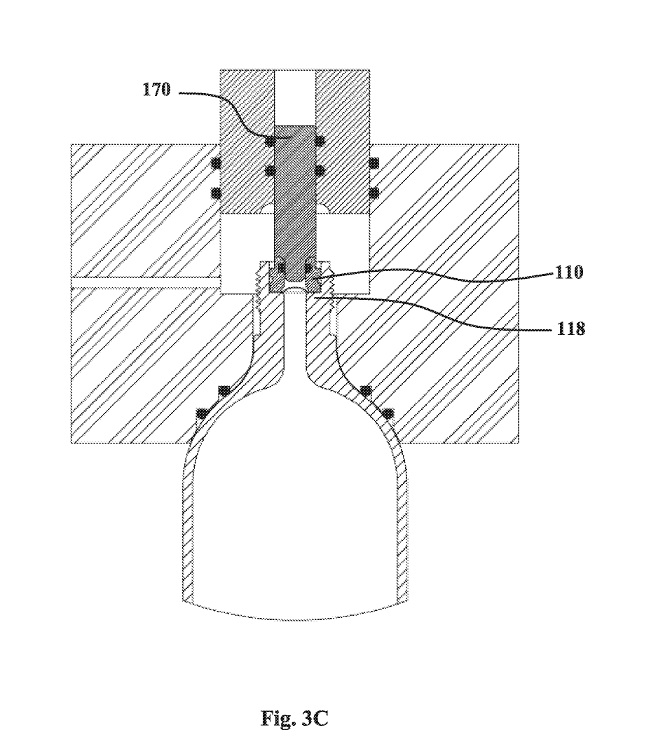

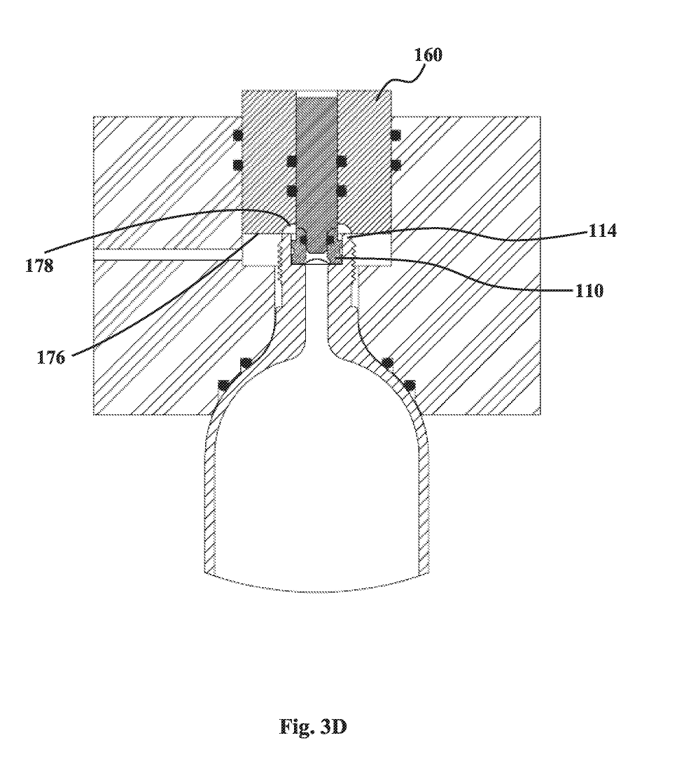

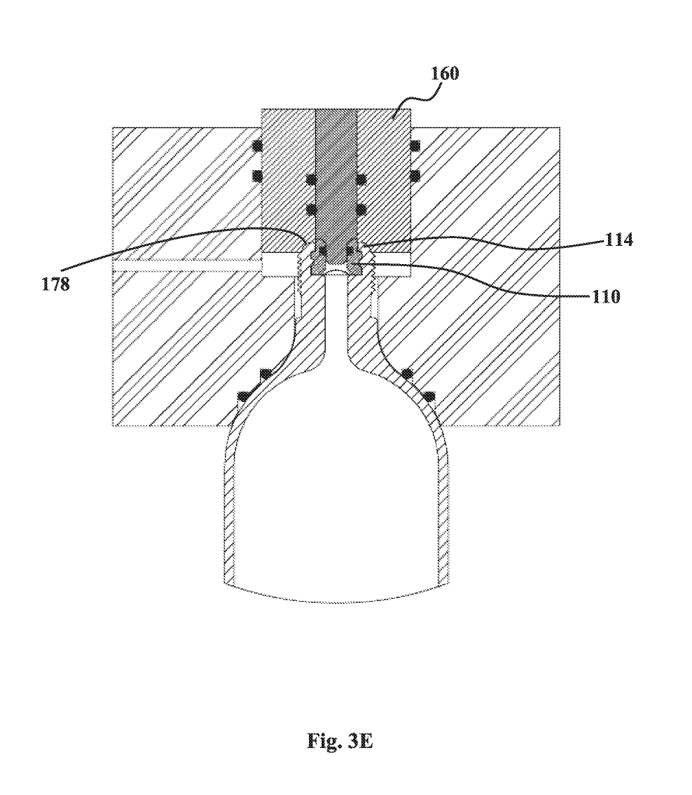

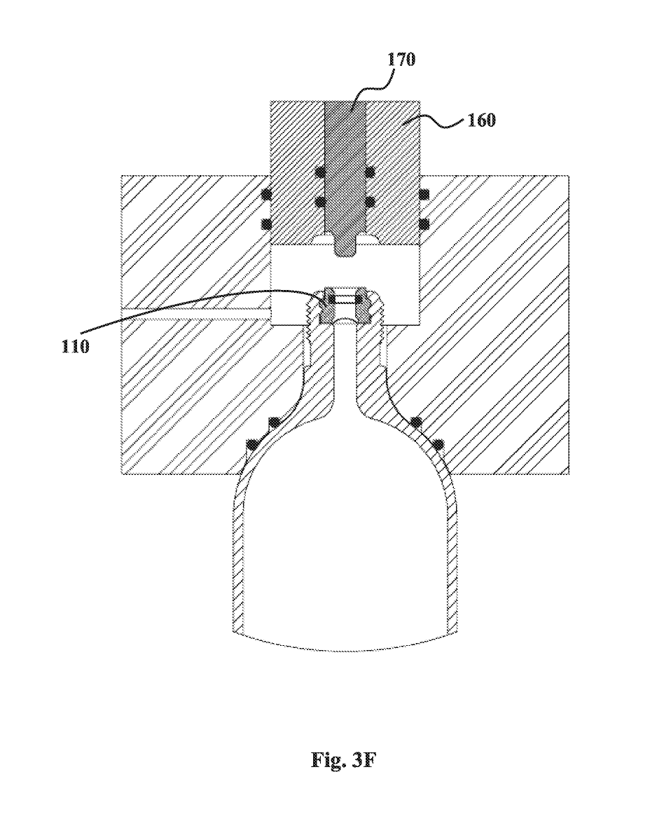

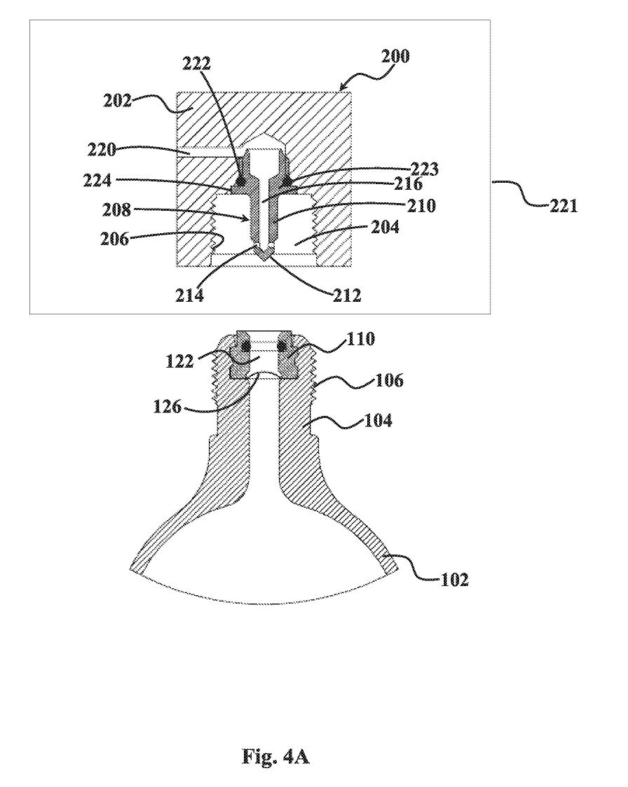

Reference is now being made to FIGS. 3A-3F showing sequences in the filling and manufacture of a canister of the kind described in FIGS. 1 and 2. The structural elements that eventually form the canister are the canister blank 132 and a plug device 110, the latter shown here fitted on the leading end of plunger 170, the function of which will be explained further below.

Further illustrated in these figures are the functional components of the apparatus for carrying out the method for said filling and manufacturing (which are annotated, particularly, in FIG. 3A). It includes the main block 140 that defines a working space 142, having axially orientated side walls 144 and an end wall 146. The end wall 146 has an opening 148 which is at the end of seat 150 that has a shape matching the upper portion of the canister blank 132.

The seat has circumferential grooves that accommodate O-rings 152, 154 and, as can be seen in FIG. 3B, once the canister is brought into association with the block, these O-rings form a gas-tight association with the external wall of the canister blank, thus hindering pressurized gas flow out of the opening 148. As can further be seen in FIG. 3B, once the canister blank is in tight association with the block, the upper portion of the neck protrudes into working space 142. The working space houses a piston 160 that can axially reciprocate between the first piston position, seen in FIG. 3B, and the second piston position, seen in FIG. 3E, that is more proximal to the end wall 146. O-rings 162, 164 accommodated within circumferential grooves in side walls 144, provide for gas-tight association between piston 160 and side walls 144.

Piston 160 also has an axial bore 166 accommodating plunger 170 that can also axially reciprocate between the first plunger position, shown in FIG. 3A or 3B, and the second plunger position, shown in FIG. 3C. In the latter position, the plunger 170 brings plug device 110 fully into the upper portion 112 of neck 104. The internal bore 166 also includes two circumferential grooves accommodating O-rings 172, 174 providing for gas-tight association between plunger 170 and walls of the bore 166. Formed at the center of leading face 176 of piston 160 is a depression 178 having a circular perimeter with dimensions corresponding to the external perimeter of upper portion 112 of neck 104. Working space 142 is linked to a gas conduit 136, which in turn is linked to a pressurized gas source shown schematically as rectangle 138 for control of the pressurized gas flow into working space 142.

The sequence of operations will now be described with reference to distinct steps shown in FIGS. 3A-3F. It should be noted that some of the described steps or details within them may be performed in different sequences or the performance of some may be partially or entirely overlap one another in the time of their performance.

Preparatory to the step shown in FIG. 3A, a plug device 110 is fitted at leading end of plunger 170 which has a circular bulging member that fits into the cavity of plug device 110. Canister blank 132, as shown in FIG. 3B, is brought into tight association with seat 150. Then pressurized gas, typically carbon dioxide, is released into working space 142 through conduit 136, as represented by arrow 190 and from there enters enclosure 103. When reaching the desired pressure, the flow of gas may be stopped and, given the gas-tight seal maintained by the gas-tights engagement of the different elements, the pressure will be maintained. Alternatively, the link to the pressurized gas may be maintained to compensate for minor pressure loss.

In the next step, shown schematically in FIG. 3C, plunger 170 is displaced from its first to its second plunger position, thus inserting plug device 110 into the terminal bore 134 until its bottom end 120 rests on shoulders 118.

In the next step, shown in FIG. 3D, piston 160 is axially displaced and when reaching the position shown in FIG. 3D, it begins to exert pressure on lips 114 and through additional downward displacement of the piston to the second piston position, shown in FIG. 3E, the upper portion is deformed to tightly fit around the external face of plug 110, this deformation including the internal bending of lips 114. The piston 160 and plunger 170 are then retracted to their respective first positions, as shown in FIG. 3F and then the canister, filled with pressurized gas and sealed by a rupturable single use plug, can be removed; and the cycle may be repeated again.

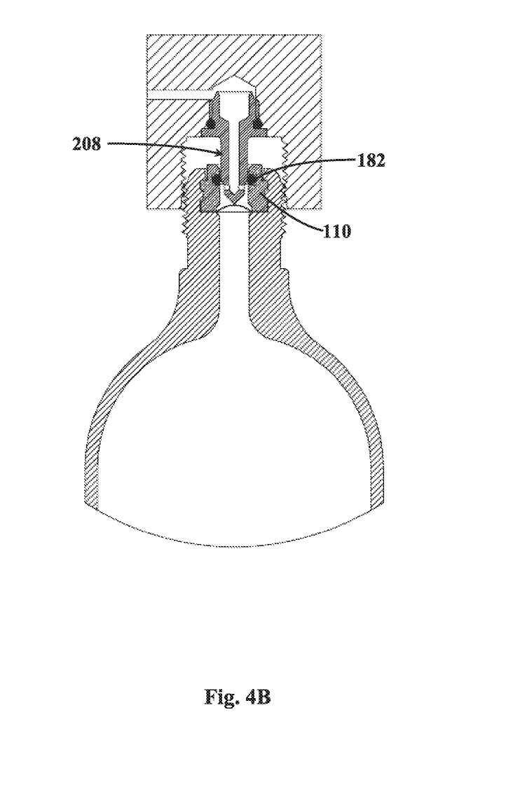

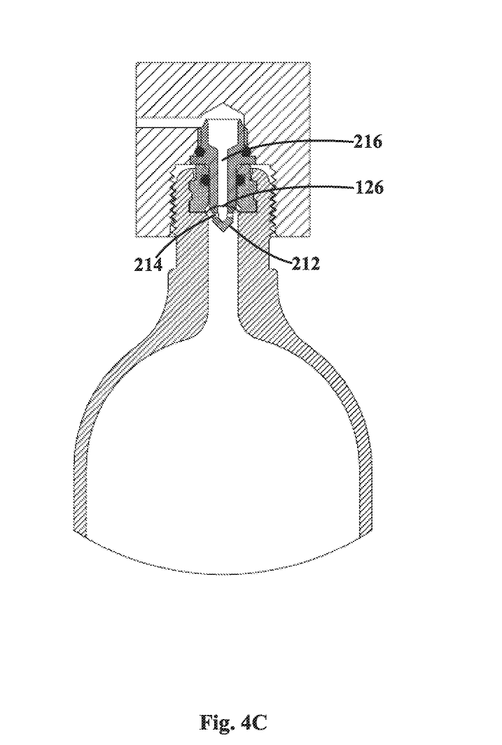

Reference is now made to FIGS. 4A and 4B showing schematic cross-section representations of the upper part of the canister and of the coupling element 200, which is part of the appliance or system schematically represented by block 221. Canister 102 with neck 104 fitted with a plug device 110 is brought into association with coupling element 200, both of which are shown separated from one another in FIG. 4A The coupling element includes a coupling body 202 having a cavity 204 with internal threading 206 and including in its center a spiked gas-channeling member 208. Gas-channeling member 208 has an elongated shaft 210, tapered end 212, openings 214 proximal to the tapered end leading into lumen 216, linked to a gas conduit 220 that is, in turn, linked to the pressurized gas conduit sub-system (not shown) of the appliance or system 221.

The spiked member has a base 223 that is accommodated in seat 224, the seat including also O-rings 222 to ensure gas-tight association. The accommodation of base 223 in seat 224 may, for example, be through a screw-type engagement.

The coupling between the coupling element and the canister neck is, in this case, a screwed type engagement; but, as can be appreciated, this is an example only of a variety of other coupling arrangements. Upon coupling, the spike member penetrates cavity 124 within plug 110 and by further screwing, as shown in FIG. 4C, it penetrates through bore 122 and ruptures barrier element 126 and consequently openings 214 come into contact with the pressurized gas in the canister and permit passage of the gas through them and through lumen 216 into the gas conduit sub-system of the appliance or system. O-rings 128 provide for gas-tight association between shaft 210 and internal walls of the plug.

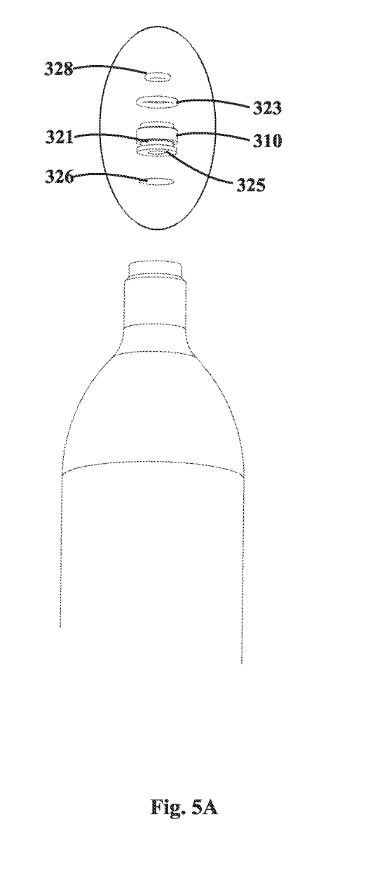

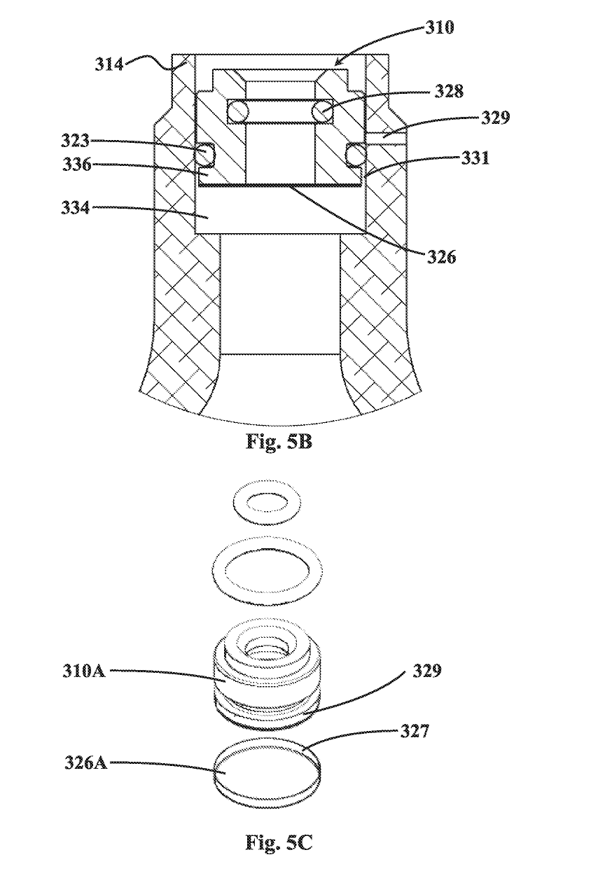

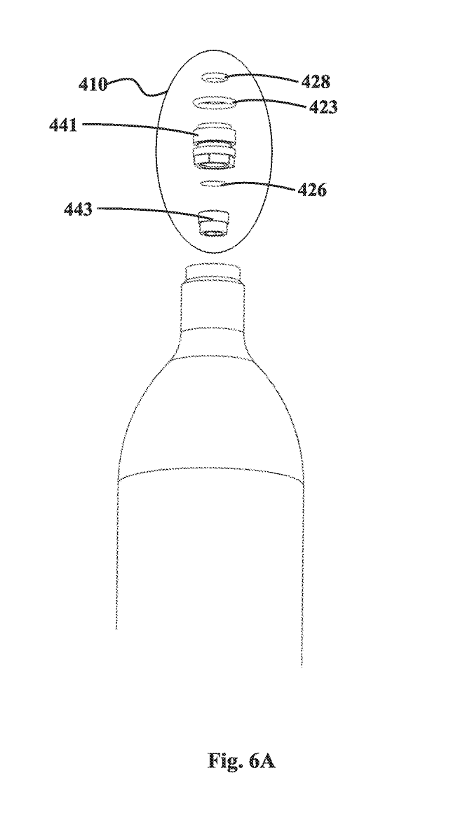

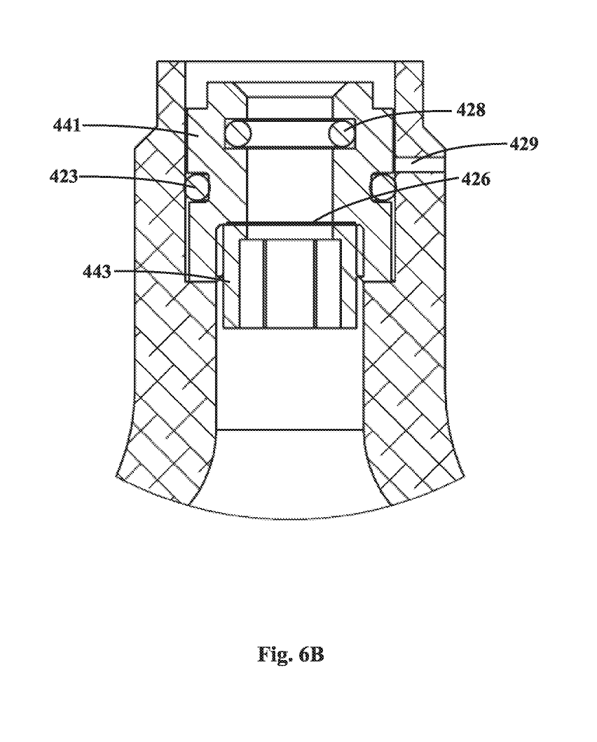

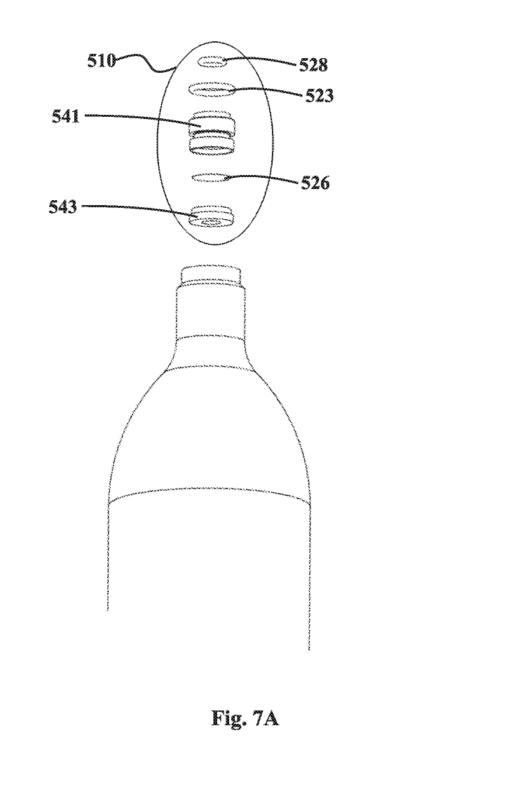

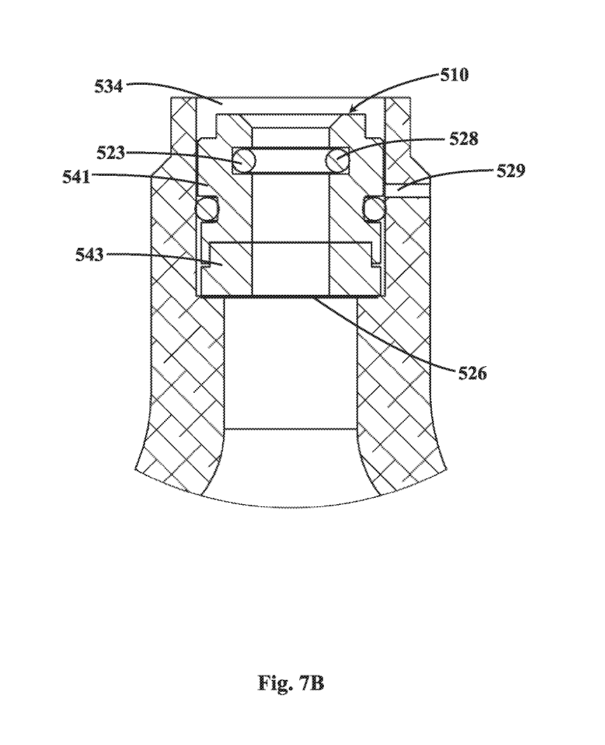

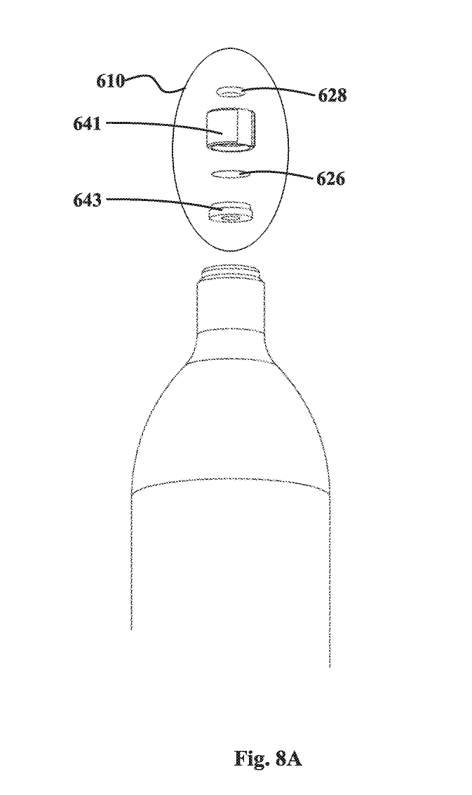

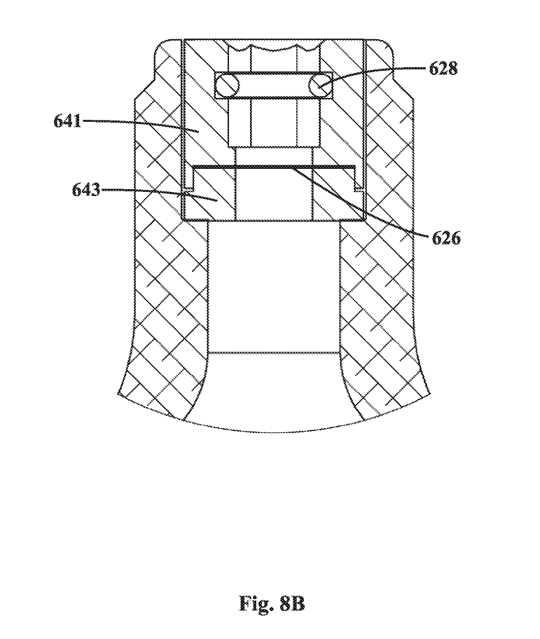

Reference is now made to FIGS. 5A-8B: In these Figures like reference numerals are used as in FIGS. 2A and 3A, shifted by 200 (FIGS. 5A-5B), 300 (FIGS. 6A-6B), 400 (FIGS. 7A-7B) and 500 (FIGS. 8A-8B) to mark like elements.

In the embodiments of FIGS. 5A and 5B, plug 310 is formed with an annular groove 321 accommodating an O-ring 323. Barrier element in the form of a thin metal sheet 326 is tightly and sealingly fixed at the inner end 325 of the plug by welding. The plug may be fitted within cavity 334 through welding or through crimping (in the latter case in a manner analogous to that described in FIGS. 3A-3F). As can further be seen in FIG. 5B, the neck of the canister blank is formed with a lateral bore 329 linking cavity 334 to the external environment. In the event that pressure within the canister increases to an excessively high level, e.g. as a result of heating, through the clearance 331 between the bottom portion of the plug and the side walls of cavity 334 the pressure will impact O-ring 323 and cause it to deform to such an extent as to permit gas release out of bore 329 to thereby reduce the pressure to safe level.

The plug 310A shown in an explode view in FIG. 5C, is structurally similar to the plug 310 of FIGS. 5A and 5B and elements having a similar function have been given like numbers with and “A” indication. The main difference is in that the barrier element 326A has the shape of a dish formed with upright walls 327 that fit around the base 329 of the plug body 310A. The barrier element 326A may be pressure fitted to base 329, may be welded or held tightly by pressing the plug body 310A against an auxiliary member or against shoulders formed within the canister neck's cavity in an analogous manner to that described in connections with FIGS. 7A and 7B.

In the embodiments of FIGS. 6A and 6B, the thin metal sheet 426 serving as a barrier element is secured in position by tight screw engagement between the plug's body 441 and auxiliary member 443, which is screw fitted into the opening at the inner end of body 441 (through external threading at the former and matching internal threading of the latter). Other than this, the plug in this embodiment is functionally similar to that of FIGS. 5A and 5B.

In FIGS. 7A and 7B the thin metal sheet 526 is also held between plug body 541 and auxiliary member 543; but, rather than screw fitting the plug body and the auxiliary member are fitted tightly one against the other while inserting them into cavity 534 during the manufacturing process, thus holding sheet 546 between them. Alternatively the auxiliary member 543 may also be welded to plug body 541.

Similarly as in the case of the embodiments of FIGS. 5A and 5B, the plug of embodiments of FIGS. 6A-7B may be secured in position through welding or pressure crimping.

In the embodiments of FIGS. 8A and 8B the auxiliary member 643 may be fitted together with plug body 641 by screw-engagement, by welding, etc. and this assembly may then be fitted into cavity 634 is by screw tight engagement through external threading in the outer face of the plug body and internal threading within the cavity.

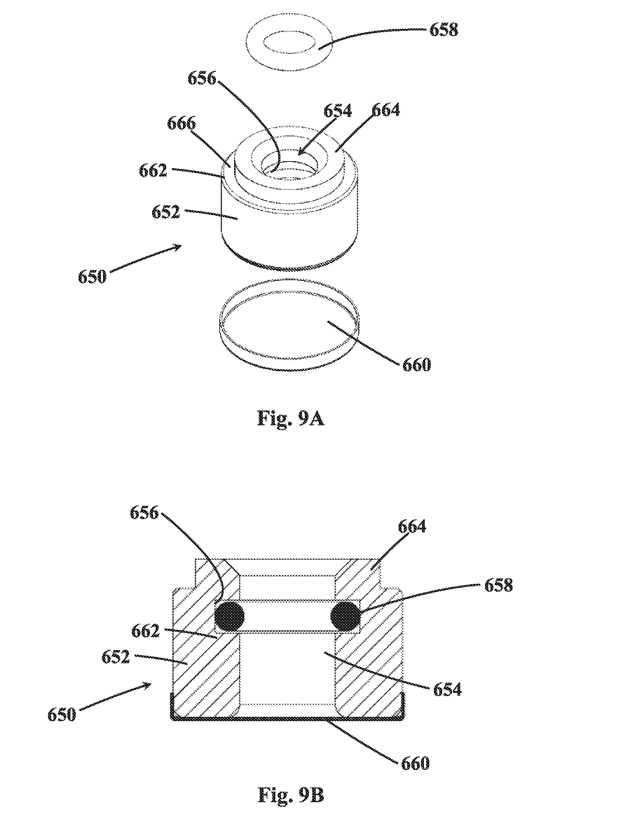

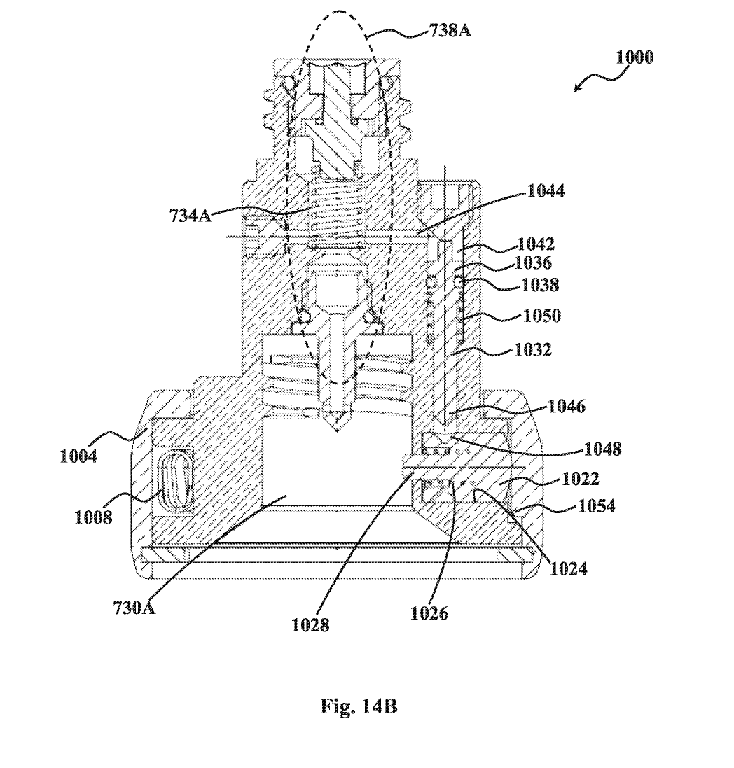

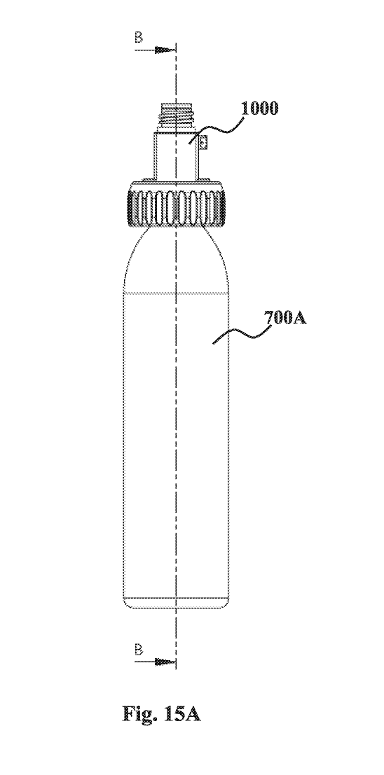

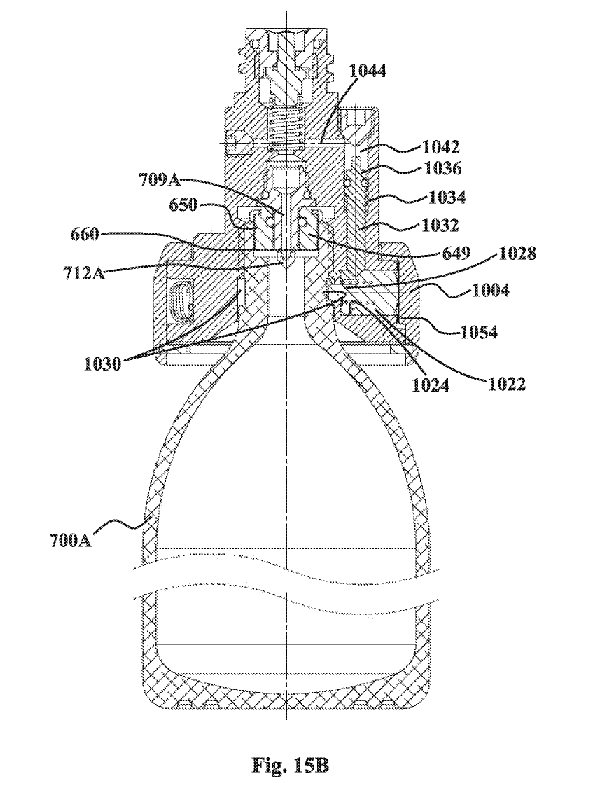

FIGS. 9A and 9B show a plug 650 that includes plug body 652 defining a central bore 654 with an annular groove 656 accommodating O-ring 658. Barrier element 660 is fitted at the bottom of body 652, for example by welding. Plug 650 is of the kind used in the canister of FIGS. 15A and 15B, to be described below, and is constituted by a first, main body section 662 and an upper, second body section 664 of narrower diameter defining between them shoulder 666. In use, as can be seen in FIG. 15B, the upper body section protrudes above the upper end of the canister's neck with the main body section 664 being in tight association with the walls of the cavity of the canister while the upper end of the walls being folded as lips over shoulder 666 to thereby ensure tight fitting of the plug in the containers neck cavity.

All the embodiments of the plug, shown above, are various configurations of a barrier element and a plug body that are separately produced and are assembled and tightly fitted to one another in a gas-tight manner, to thereby form the plug. It should be noted, however, that it is also possible, under other embodiments of this disclosure, to construct the plug body and the barrier element out of a single integral metal block, e.g. through machining, a die casting or a combination of the two.

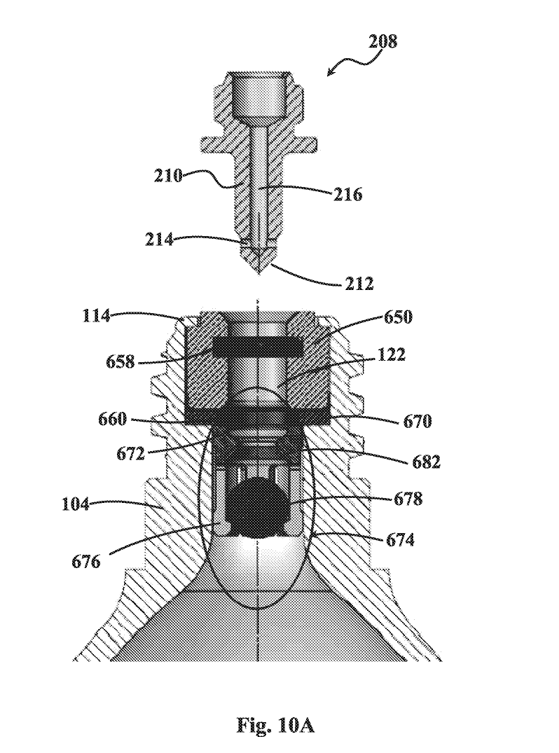

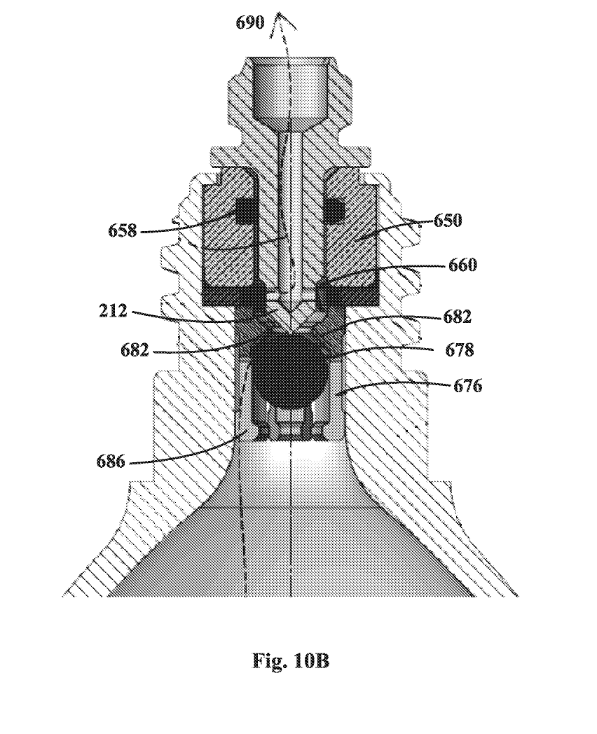

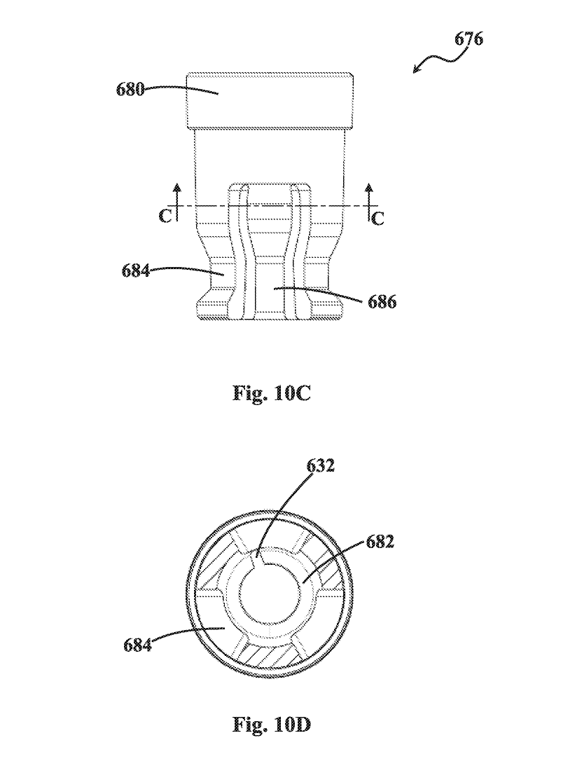

Reference is now being made to FIGS. 10A-10D showing the upper portion of a canister 102 where the neck 104 accommodates a plug 650, of the kind shown in FIGS. 9A-9B and, also, a flow-restricting element 674 situated interior (or below, in the orientation of the canister in these figures) to plug 650. Plug 650 is held within the upper part of neck 104 between lips 114, tightly holding the plug in its upper end, and between disk 670 that define a central void 672. The flow-restricting element 674 that is situated below disk 670 includes a nesting member 676 and a spherical floating member 678. As can best be seen in FIG. 10C, nesting member 676 has an upper segment 680 that is snugly associated with the surrounding inner walls of the neck and has a slanted lower surface 682 that defines a seat for member 678. The lower segment 684 of nesting member 676 has arms that define a cage between them that accommodates member 678 and are provided with displacement-restricting abutments 686 that limit the downward vertical displacement of member 678. Consequently, member 678 can vertically displace between an uppermost position in which it is seated in seat 682 and a lowermost position, in which it rests on abutments 686, as seen in FIG. 10A.

In FIG. 10A, barrier element 660 is intact and accordingly there is no outflow of gas. Once barrier element 660 is pierced, gas outflows and, consequently, floating member 678 moves upward with the gas to come to rest within seat 682. In this position of member 678 gas outflow is limited, whereas as long as member 678 is removed from seat 682, gas can outflow in a unrestricted manner.

Upon coupling of the canister's neck with gas-channeling member 208, shaft 210 penetrates through lumen 122, in a manner similar to that described above, to rupture barrier 660 and in its fully coupled state, openings 214 come to be positioned within void 672. At this state the tapered end 212 of the shaft limits the upward displacement of member 678, as seen in FIG. 10B and gas outflows through a flow path represented by arrow 690. This gas outflow causes upward displacement of member 678 to the position seen in FIG. 10B.

In the event of premature decoupling, when there is still gas pressure remaining within the canister, the pressure differential between the canister's interior and the exterior will cause upward displacement of floating member 678 to its fully upward position to rest within seat 682.

As can best be seen in FIG. 10D, seat 682 is formed with a vertical notch 692 that defines an open gas channel that permits gas outflow even when member 678 is seated in seat 682. This then enables trickled gas outflow and, hence, gradual pressure reduction from within the canister. Thus, according to this embodiment, in the event of decoupling, gas pressure will not be released in a burst but will rather be gradual and also relatively quiet.

In the embodiments shown in FIGS. 10A-10D, the floating member is made to be light, e.g. is a hollow member or made of a low-density material, such as a low density polymeric material, foamed polymers, thin-walled aluminum hollow sphere, etc. As can be appreciated, in other embodiments, member 678 may also be biased into its seated position by biasing elements, e.g. a spring. Furthermore, in other embodiments, the member may have shapes other than spherical.

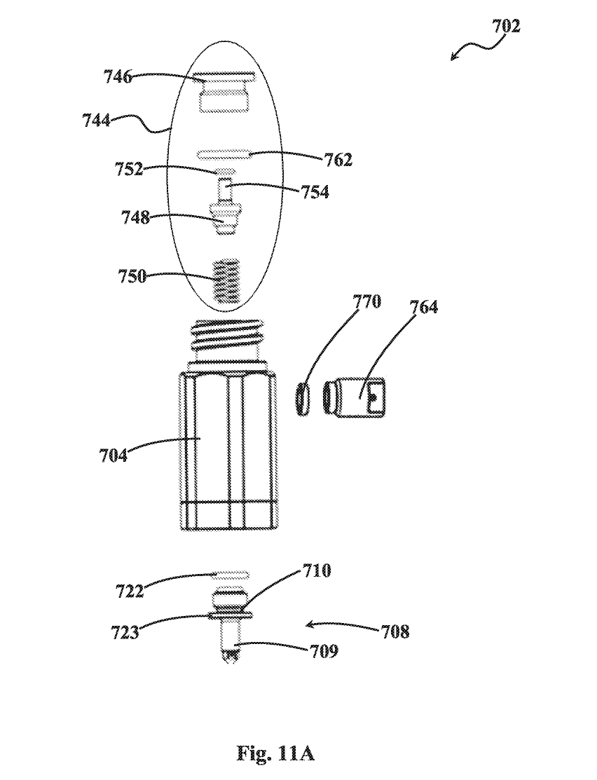

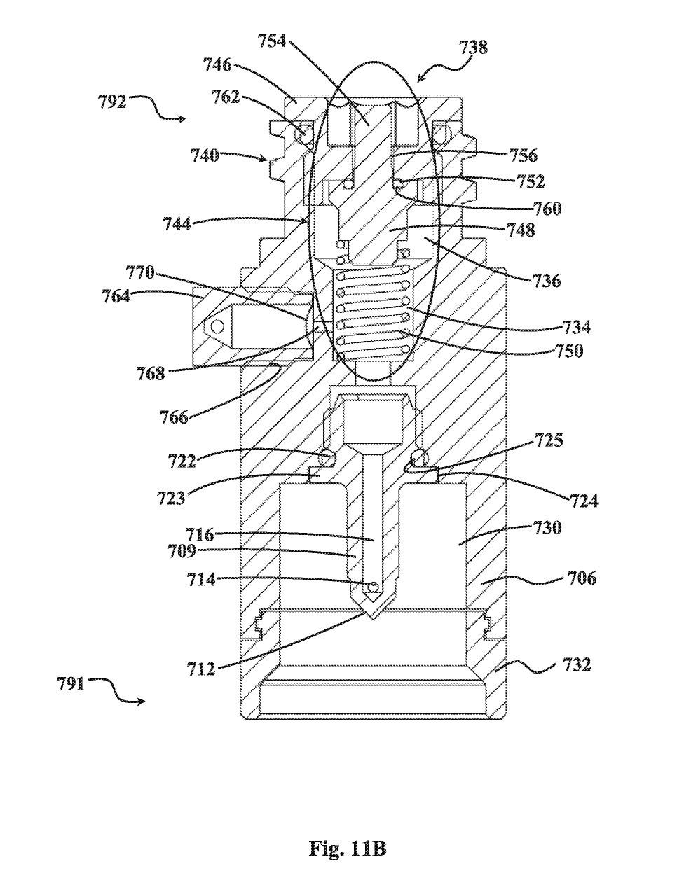

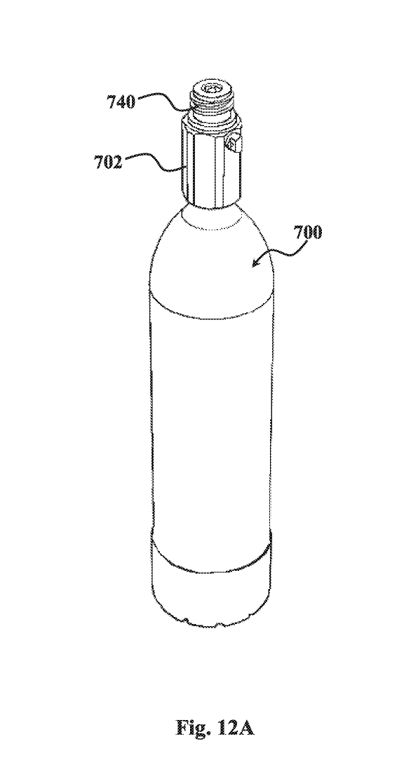

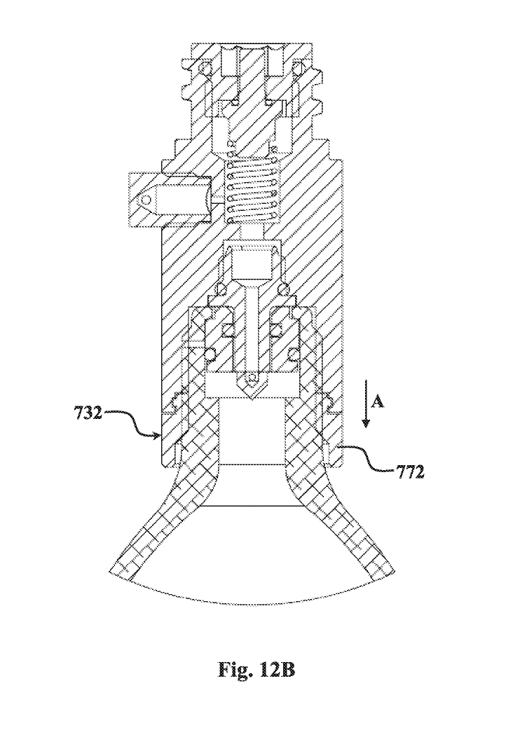

Referring now to FIGS. 11A and 11B, shown is a coupling device 702 for coupling to a canister 700 (illustrated in FIGS. 12A and 12B). The device is configured for coupling to the canister in a screw-type manner, at its one end 791 and for coupling to the gas-port of the appliance or system, again in a screw-type manner, at its other end 792. It should be noted that screw-type coupling is an example and other means of coupling may be used (e.g. snap fit coupling, latches-based coupling, bayonet type coupling and others).

Device 702 is comprised of device body 704, a cup-shaped connector element 706 and gas channeling member 708 at end 791, safety plug 718, and valve element 724 at end 792. Gas channeling member 708 has a structure similar to gas channeling member 208 shown in FIG. 4B and includes a shaft 709 with a tapered end 712 having openings 714 leading into lumen 716. Lumen 716 is part of a gas conduit, marked 738 that extends between the two ends 791, 792 and includes also spring-accommodating cavity 734 and valve-accommodating cavity 736.

Member 708 has a base 723 which is fitted within a seat 724 and is configured with a lateral groove 725 accommodating O-ring 722 that provides for a gas-tight seal to avoid leakage out of said gas conduit.

The shaft 709 of member 708 protrudes into cavity 730 within cup-shaped connector element 706, the side walls of which are internally threaded (the threading—not shown). Connector element 706 is constituted by side walls which extend from body 704 and by a fastening element 732 that is coupled to said walls in a screw-type manner. Turning of the fastening ring 732 will distance it away from the member and owing to the outwardly tapering contour of the neck the external lips of ring 732 will then bear tightly against the tapering portion to thereby secure the coupling of the coupling device to the canister.

The other end of the device has an external, coarse screw threading 740 for coupling with a matching connector (not shown) of an appliance or system.

Valve 744 includes a base 746, plunger 748, spring 750 and O-ring 752. Plunger 748 has a stem 754 that is accommodated within bore 756 in base 746 and can axially displace against the biasing force of spring 750 that is accommodated with spring-accommodating cavity 734. In the position shown in FIG. 11B, the plunger is in its fully biased state with its shoulders 758 pressed against base 746 and O-ring 752, accommodated within circular groove 760, thereby sealing egress of gas out of valve-accommodating cavity 756. Once coupled with said device or appliance, stem 754 is pushed against the bias of spring 750 causing shoulders 758 to distance from base 746, thus permitting gas egress through the clearance between stem 754 and bore 756. Base 746 is fitted within cavity 736 in a screw type engagement and is associated with O-ring 762 to ensure a gas-tight association between the base and the device.

Cavity 766 accommodates safety plug 764 and is linked through conduit 768 to spring-accommodating cavity 734. The conduit 768 is sealed by membrane 770 and when pressure increases above a defined threshold level, membrane 770 opens permitting gas release to the outside.

FIGS. 12A and 12B show a coupling device of the kind described above coupled to a canister. As can now be better understood, turning of fastening element 732 so that it will be downwardly displaced, in the direction of arrow A, will press lips 772 against the wider portion of the neck to thereby practically lock the device in this coupling position. Once so coupled, as explained above, coupling of the device with the appliance or system at its other end will cause gas flow through said conduit into the gas-port of the appliance or system (not shown).

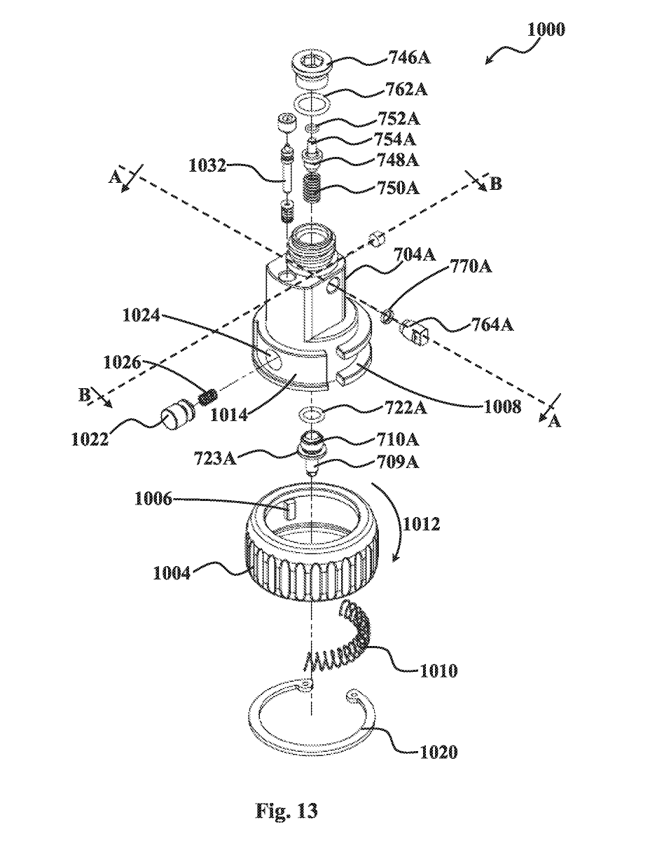

Reference is now being made to FIGS. 13-15B showing a coupling device, generally designated 1000, of another embodiment which, as already noted above, includes a safety arrangement that prevents premature or accidental decoupling between the device and a pressurized carbon dioxide canister, namely, decoupling it while there is still carbon dioxide pressure in the canister exceeding a predetermined gas pressure.

In FIGS. 12-14B, the same reference numerals as those used in FIGS. 11A-12B have been used with the indication “A” to denote elements having the same or similar function. Thus, by way of example, element 746 of FIGS. 11A and 11B will be equivalent to element 746A of the embodiment of FIGS. 13-15B. The reader is referred to the description above of the embodiments of FIGS. 11A-12B for explanation of the role and/or function of these elements. The description below will focus primarily on those elements that are distinct from the embodiments described above.

Coupling device 1000 has a base portion 1002 and accommodates a cup-shaped cavity 730A that is internally screw-threaded and adapted for screw-tight coupling with the neck of a canister.

Fitted over the base portion 1002 is a ring element 1004 having an internal guiding projection 1006 that fits into groove 1008 defined on the exterior of base portion 1002, to thereby guide circular rotation of ring 1004. Accommodated in groove 1008 is also a helical spring 1010 that rests against projection 1006 at its one end and a barrier at the end of groove 1008 (not shown). The urging force of spring 1010 biases the ring to rotate in a direction represented by arrow 1012 (clockwise in FIG. 13) into the ring's locking state. The ring is secured into position by means of fastening ring 1020.

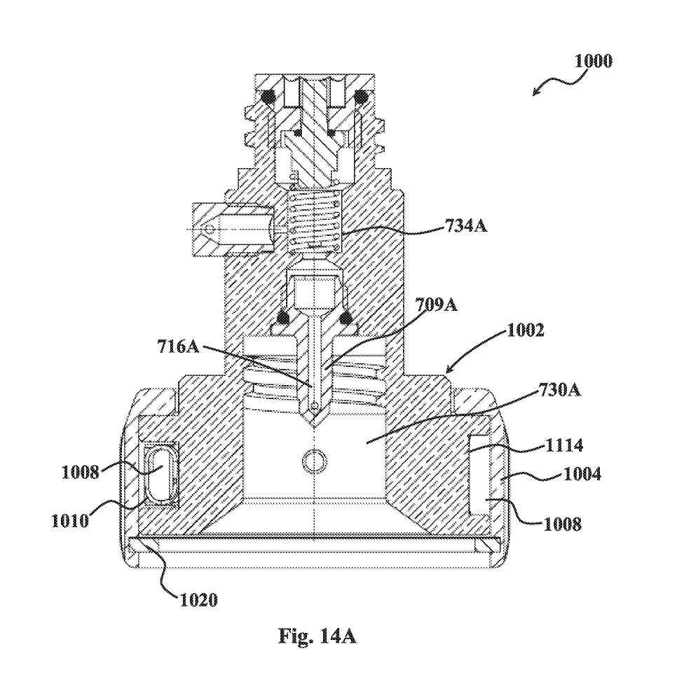

Coupling device 1000 also includes a safety bolt 1022 which fits into bore 1024 and has an associated spring 1026 that biases the bolt element in a radial direction from a first, locking position to a second, releasing position of the bolt. Safety bolt 1022, as can be seen in FIGS. 14B and 15B, has a projection 1028, that upon coupling of the coupling device 1000 with the neck of canister 700A, can, when the bolt is in its locking position, fit into and be accommodated in groove 1030 formed in the canister's neck, as can be seen in FIG. 15B. As long as bolt 1022 is in its locking position in which projection 1028 is accommodated within groove 1030, coupling device 1000 cannot be decoupled from the canister.

The safety arrangement of this embodiment includes, in addition to safety bolt 1022, also blocking pin 1032 that is accommodated in pin bore 1034. Pin 1032 has a broader shoulder 1036 at its rear end, snugly associated with the walls of pin bore 1032 having a lateral groove accommodating an O-ring 1038 that forms a gas tight seal with the walls of bore 1032 and thereby defining a head space 1042. Head space 1042 is linked through lateral bore 1044 to cavity 734A, which is part of the gas conduit 738A within the coupling device.

When pressurized gas enters the head space 1042 through lateral bore 1044, it applies downward pressure on pin 1032 which is then axially displaced from its position shown in FIG. 14B towards bolt 1022 to position seen in FIG. 15B, in which the tip 1046 of the pin is accommodated into a matching peripheral groove 1048 of bolt 1022, to thereby locking bolt 1022 in the position shown in FIGS. 14B and 15B, in which projection 1028 is accommodated within groove 1030. In this state the device cannot be decoupled from the canister, as explained above.

Pin 1032 is associated with spring 1050 that provides a biasing force on the pin in a direction away from bolt 1022. Once pressure in the canister and consequently also in head space 1042 is reduced below a certain pressure (that is a pressure defined by the properties of the spring, where the force acting by the gas pressure on shoulders 1036 equals the opposite biasing force of the spring), pin 1032 can then be displaced away from the bolt, by the force of the spring to the position shown in FIG. 14B, thereby permitting radial displacement of bolt 1022 to its unlocking position.

Ring 1004 has an abutment 1054, seen cross-section in FIG. 14B, which during rotation of the ring slides over track 1014. When abutment 1054 comes to rest over bolt 1022, it pushes the bolt into its locking position. Once the ring is rotated against the bias of spring 1008, the bolt can be displaced away from the neck to permit decoupling.

Locking of the coupling device 1000 onto the neck of a canister, upon coupling, is in fact automatic. Once the canister's neck is coupled with the device, as seen in FIG. 15B, barrier element 660 is ruptured by the tip 712A of elongated shaft 709A, whereby pressurized gas can enter into the gas ducting system 738A and from there to head space 1042 of bore 1034. Consequently, the gas pressure in the canister and in the head space 1042 of bore 1034 will be the same. This pressure then forces pin 1032 to displace against the bias of spring 1050. Ring 1004 is biased into a locking state by spring 1010 whereupon abutment 1054 forces bolt 1022 into its locking position, as shown in FIG. 15B against the bias of spring 1026, whereupon pin 1032 can move downward locking bolt 1022 and lock it in its locking position.

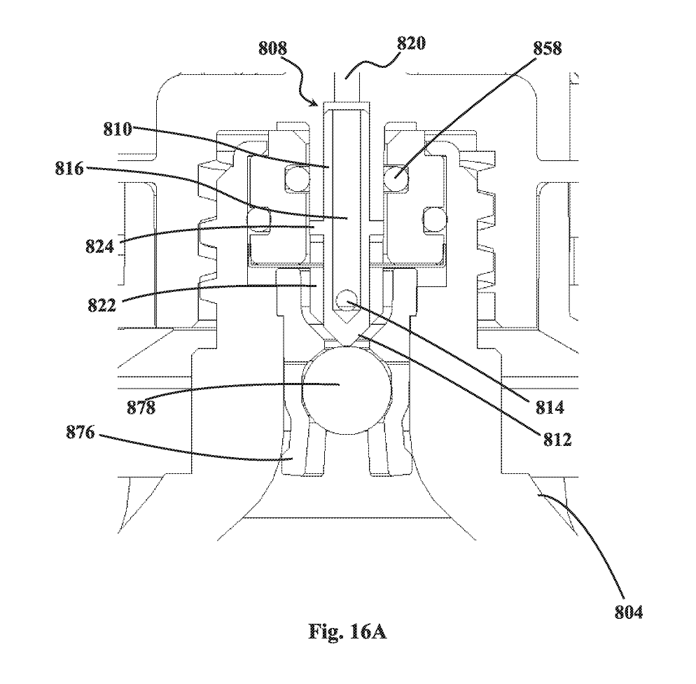

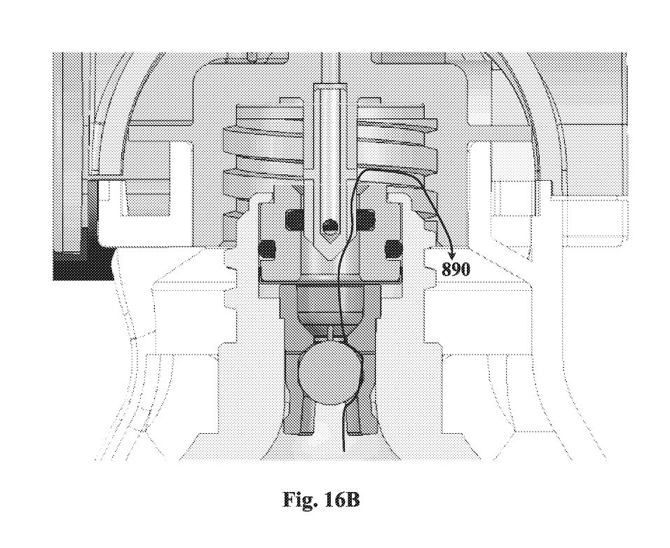

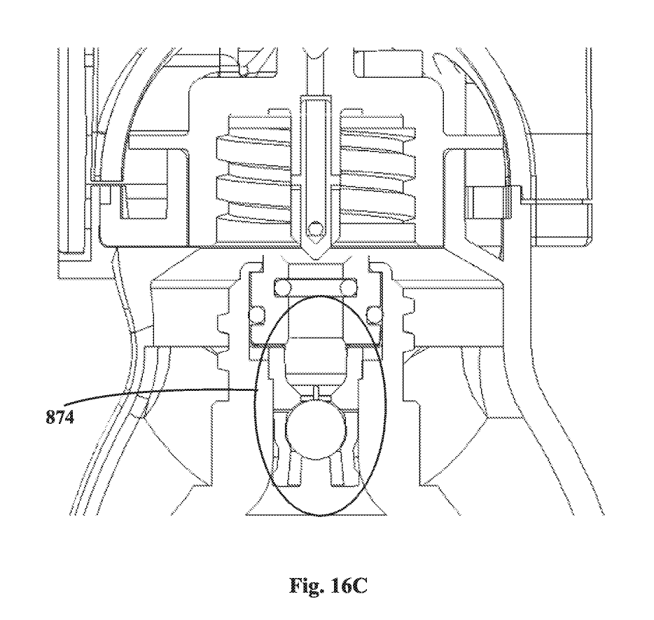

Reference is now being made to FIGS. 16A-16C showing neck 804 of a canister having a flow-restricting element of the kind similar to that shown in FIGS. 10A-10D; and, accordingly, like reference numerals are used shifted by 200 to define like elements. The reader is referred to the description of FIGS. 10A-10D for an explanation of structure and function.

The coupling element 808, which in this embodiment forms a functional element of an appliance or system (although similar functional coupling features may also be included in a coupling element that is an independent device), includes a shaft 810 with a shaft end 812 that in the coupling state, shown in FIG. 16A, bears on floating member 878 to permit gas flow through apertures 814 into lumen 816 and from there to the gas conduit, an initial segment thereof 820 being seen in this figure.

Shaft 810 is formed with a peripheral axial recess 822 that extends upward from shaft end 812 and ending at shoulders 824. In the coupled state shown in FIG. 16A, gas outflow along the periphery of the shaft is prevented by O-ring 858.

During decoupling, as seen in FIG. 16B, the shaft is relatively axially displaced away from the neck and, once shoulders 824 extend upwards to O-ring 858, the recess 822 permits gas outflow along the lines represented by arrow 890. This enables controlled release of pressure, avoiding violent release of pressure in the fully decoupled state shown in FIG. 16C. In this case, such violent release is further avoided by the flow-restricting element 874.

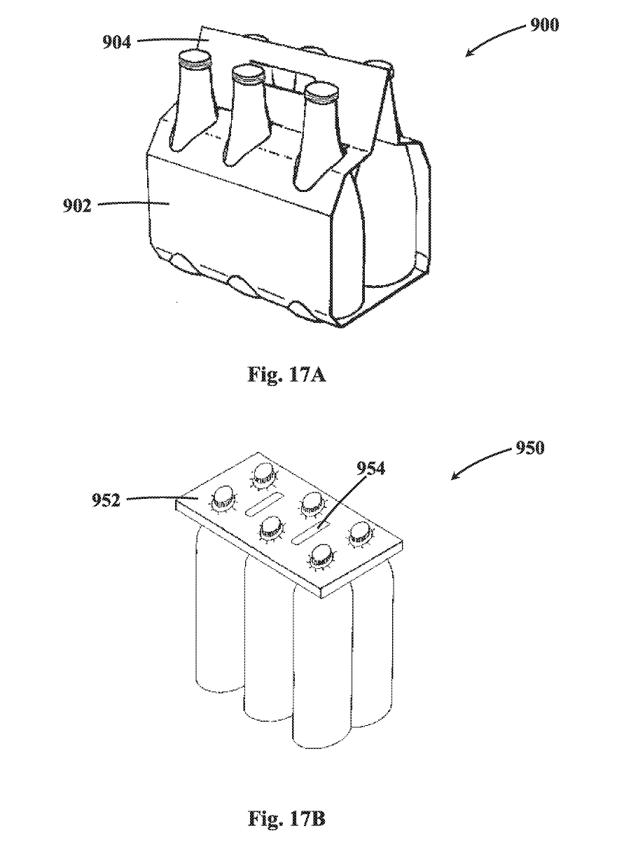

Reference is now made to FIGS. 17A and 17B showing two different examples of multipacks (6-pack in these examples) 900, 950 of canisters of the kind described above. Each one includes respective holding racks 902, 952 for canisters 100 and integral carrying handles 904, 954. The racks and the handles may, for example, be made of plastic or cardboard.

1. A pressurized gas container for association with and supplying gas to a pressurized gas port of an appliance or system, the container comprising:
a container body, defining a pressurized gas enclosure, and a neck integral therewith defining a gas outlet;
the neck having an end portion that is configured for coupling with a coupling element, which may be a coupling element integral with or forming part of said gas port or may be a coupling element of a coupling device or adapter configured for coupling with said port, a plug being fitted within the neck;
the plug having a barrier element sealing said enclosure and configured for non-reversible rupturing by a shaft of a gas-channeling member of said coupling element, and having one or more sealing elements, distinct from said barrier element and configured for forming a gas-tight association with said shaft; and
the container comprising a flow-restricting element fitted within the neck, situated interior of the plug, and configured to permit (i) free flow of pressurized gas as long as the neck is coupled to the coupling element and (ii) gradual outflow of gas upon decoupling of the coupling element from the neck.

2. The container of claim 1, wherein the flow-restricting element comprises a floating member displaceable between a seated position in which it bears against a seat at an outlet of the container to thereby partially seal the container's outlet and an unseated position in which it is distanced from said seat and permitting free gas outflow through said outlet, said floating member being biased into said seated position and being configured for displacement into said unseated position by the shaft of said gas channeling member.

3. The container of claim 2, wherein said floating member is rounded, e.g. spherical.

4. The container of claim 1, wherein said flow-restricting element comprises a nesting member fitted within the container's neck and having an upper segment defining said seat and a lower segment comprising arms configured to limit displacement of said floating member.

5. The container of claim 4, wherein the seat defines flow channels.

6. The container of claim 5, wherein flow channels are defined between the seat and the neck's interior face.

7. The container of claim 1, wherein the pressurized gas within the container is pressurized carbon dioxide, and is intended for association with a carbonated drink dispensing appliance or system in which the pressurized carbon dioxide is utilized for the preparation of the carbonated drink.

8. The container of claim 7, wherein the container is configured for association with said appliance or system such that the pressurized carbon dioxide for the preparation of the carbonated drink is drawn when needed out of the container.

9. The container of claim 1, wherein the gas is carbon dioxide and the appliance or system is adapted for the preparation of a carbonated drink.

10. The container of claim 1, wherein said barrier element is a pierceable metal sheet.

11. The container of claim 10, wherein said sheet is configured for rupturing in the event that the pressure within the container exceeds a predefined threshold.

12. The container of claim 1, wherein said plug defines an axis extending between an exterior end and an interior end and being formed with a generally axial bore extending between the two ends.

13. The container of claim 12, wherein said barrier is formed at said interior end of the bore and said one or more sealing elements are formed within said bore at said exterior end or in between said interior and said exterior end.

14. The container of claim 13, wherein the one or more sealing elements are one or more O-rings.

15. The container of claim 14, wherein said O-ring is fitted within a circumferential groove formed in the walls of said bore.

16. The container of claim 1, wherein said body has an average wall thickness that is less than 60%, 55%, 50%, 45% or even less that 40% of the average wall thickness of a container of similar dimensions and made of similar material that is intended for multiple use.

17. A coupling element for coupling a pressurized gas container of claim 1, to an appliance or system to permit gas supply to a gas conduit system of the appliance or system, the element comprising a gas channeling member having an elongated shaft that extends axially from a base to a shaft end, the shaft being configured for fitting into a bore of a plug in the opening of the container and, once coupled with the container, causes irreversible opening of a barrier element formed at an inner end of said bore; the shaft having openings at or proximal to the shaft end leading into said gas conduit.

18. The element of claim 17, defining also one or more gas release channels that are configured to form a gas-release conduit between the container's interior and the exterior during decoupling of the container and the coupling element.

19. The element of claim 18, wherein such gas-release conduit being constituted by one or more axial grooves or recesses at the shaft's face that faces the bore's internal walls.

20. The element of claim 18, being (i) an element of said appliance or system, or (ii) an independent device for coupling the container to a gas port of the appliance or system.
